(19) United States
(12) Patent Application Publication
(10) Pub. No.: US 2025/0225366 A1
(43) Pub. Date: Jul. 10, 2025

(54) SIGNAL PROCESSING DEVICE, SIGNAL PROCESSING METHOD, AND COMPUTER PROGRAM PRODUCT

(71) Applicant: KABUSHIKI KAISHA TOSHIBA, Tokyo (JP)

(72) Inventors: Kazuki MINEGISHI, Kawasaki Kanagawa (JP); Kumiko NOMURA, Shinagawa Tokyo (JP); Yoshifumi NISHI, Yokohama Kanagawa (JP)

(73) Assignee: KABUSHIKI KAISHA TOSHIBA, Tokyo (JP)

(21) Appl. No.: 19/000,955

(22) Filed: Dec. 24, 2024

(30) Foreign Application Priority Data
Jan. 4, 2024 (JP) 2024-000027

(51) Int. Cl. G06N 3/04; G06N 3/08

(52) U.S. Cl. CPC G06N 3/04; G06N 3/08

(57) ABSTRACT

A signal processing device executes signal processing according to a neural network. The signal processing device includes a processor that functions as an input layer, an intermediate layer, and an output layer. The intermediate layer acquires one or more intermediate input signals corresponding to the input signal and generates intermediate signals based on the one or more intermediate input signals. The output layer acquires intermediate output signals and outputs output signals corresponding to the intermediate output signals. The intermediate layer includes N intermediate neurons and intermediate synapses. Each of the intermediate synapses generates a corresponding intermediate signal among the intermediate signals in accordance with the state value output from any one intermediate neuron of the N intermediate neurons. The N intermediate neurons include P types with different update rules.

### CROSS-REFERENCE TO RELATED APPLICATIONS

This application is based upon and claims the benefit of priority from Japanese Patent Application No. 2024-000027, filed on Jan. 4, 2024; the entire contents of which are incorporated herein by reference.

### FIELD

Embodiments described herein relate generally to a signal processing device, a signal processing method, and a computer program product.

### BACKGROUND

It has been proposed to detect abnormalities of time-series data measured by a medical device or infrastructure equipment that continuously operates. In addition, it has also been proposed that such abnormalities of the time-series data are detected using artificial intelligence in a terminal device provided in the vicinity of the medical device, infrastructure equipment, or the like. By detecting abnormalities in the terminal device, for example, the amount of data to be transmitted to the cloud can be suppressed.

However, calculation resources of the terminal device are limited. Therefore, the terminal device needs to detect the abnormalities by using artificial intelligence with a small calculation cost.

In addition, noise is superimposed on time-series data measured by the medical device, infrastructure equipment, or the like depending on a measurement place or the like. In a case where the abnormalities are detected from the time-series data on which noise is superimposed, the detection accuracy decreases. Therefore, for example, in a case where the abnormalities are detected from the time-series data on which noise is superimposed, an information processing device needs to perform spectrum analysis such as fast Fourier transform on the time-series data to remove the noise.

However, spectrum analysis is very computationally expensive. For this reason, in the case where the abnormalities of the time-series data are detected in the terminal device provided in the vicinity of the medical device, infrastructure equipment, or the like, it is difficult to perform noise removal using spectrum analysis.

### BRIEF DESCRIPTION OF THE DRAWINGS

FIG. 1 is a configuration diagram of a signal processing device according to a first embodiment;

FIG. 2 is a configuration diagram of a signal processing device according to a second embodiment;

FIG. 3 is a configuration diagram of a signal processing device according to a third embodiment;

FIG. 4 is a configuration diagram of a signal processing device according to a fourth embodiment;

FIG. 5 is a configuration diagram of a signal processing device according to a fifth embodiment;

FIG. 6 is a configuration diagram of a signal processing device according to a sixth embodiment;

FIG. 7 is a configuration diagram of a signal processing device according to a seventh embodiment;

FIG. 8 is a configuration diagram of a signal processing device according to an eighth embodiment;

FIG. 9 is a configuration diagram of a signal processing device according to a ninth embodiment;

FIG. 10 is a diagram describing update according to STDP;

FIG. 11 is a diagram describing update according to the Fusi rule;

FIG. 12 is a diagram illustrating a modification of an output neuron;

FIG. 13 is a diagram illustrating a modification of an output layer;

FIG. 14 is a diagram illustrating a modification of an input-intermediate synapse unit;

FIG. 15 is a waveform diagram of an input signal used for simulation;

FIG. 16 is a waveform diagram of a signal representing a simulation result;

FIG. 17 is a configuration diagram of an abnormality detection system; and

FIG. 18 is a hardware configuration diagram of an information processing device.

### DETAILED DESCRIPTION

A signal processing device according to one embodiment executes signal processing according to a neural network. The signal processing device includes a hardware processor connected to a memory. The hardware processor is configured to function as an input layer, an intermediate layer, and an output layer. The input layer is configured to acquire M input signals (M is an integer of 1 or more). The intermediate layer is configured to acquire one or more intermediate input signals corresponding to the M input signals and generate intermediate signals based on the one or more intermediate input signals. The output layer is configured to acquire intermediate output signals and output an output signal corresponding to the intermediate output signals. The intermediate layer includes N intermediate neurons (N is an integer of 2 or more) each being configured to output a state value, and intermediate synapses configured to generate the intermediate signals. Each of the intermediate synapses generates a corresponding intermediate signal among the intermediate signals in accordance with the state value output from one of the N intermediate neurons. Each of the intermediate output signals is a signal corresponding to the state value output by the one of the N intermediate neurons. Each of the N intermediate neurons changes the state value with the lapse of time based on a predetermined update rule in accordance with at least one of the one or more intermediate input signals or the intermediate signals. The N intermediate neurons include P types (P is an integer of 2 or more and N or less) whose update rules are different.

### First Embodiment

A signal processing device 10 according to a first embodiment will be described.

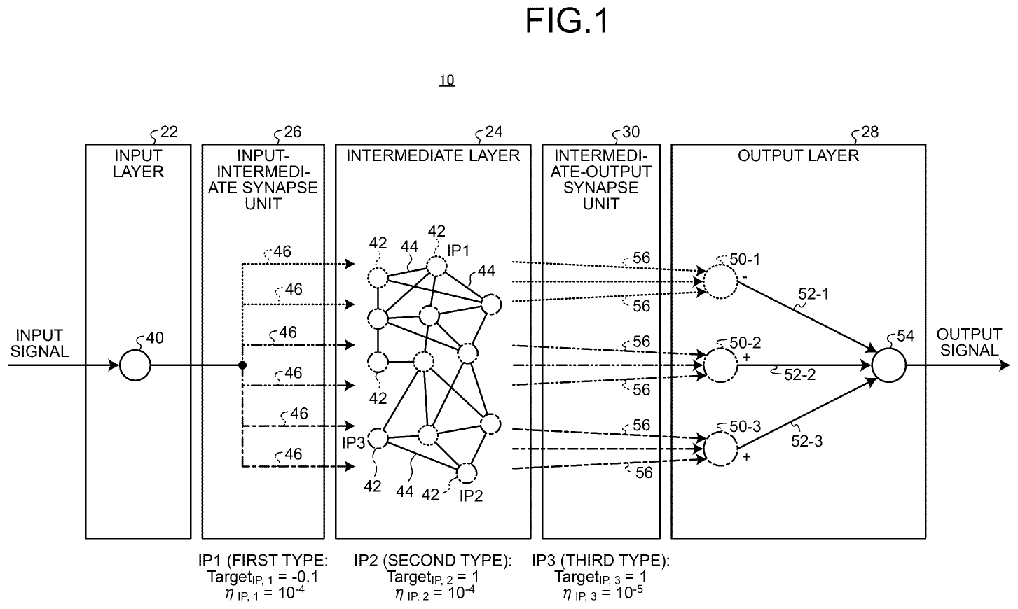

FIG. 1 is a diagram illustrating a configuration of a signal processing device 10 according to a first embodiment.

The signal processing device 10 according to the first embodiment acquires a time-series input signal and outputs an output signal representing an abnormal component included in the input signal.

The signal processing device 10 may execute signal processing by digital calculation by a computer, or may execute signal processing by an analog circuit or a digital circuit. Furthermore, in the signal processing device 10, a digital circuit and an analog circuit may be mixed. The signal processing device 10 may acquire a digital input signal or an analog input signal. The digital input signal may be a signal representing a digital value of a predetermined number of resolutions, a signal representing a binary value, or a signal representing a discrete value of two or more values for each sampling time. The analog input signal may be a signal whose level indicates a continuous value or a signal whose pulse width changes with the level.

The signal processing device 10 executes signal processing according to a neural network. More specifically, the signal processing device 10 executes signal processing according to the recurrent neural network.

In the present embodiment, the signal processing device 10 executes processing according to a neural network including an input layer 22, an intermediate layer 24, an input-intermediate synapse unit 26, an output layer 28, and an intermediate-output synapse unit 30.

The input layer 22 acquires an input signal. The input layer 22 includes an input neuron 40. The input neuron 40 changes an input state value represented by a real number with the lapse of time in accordance with to an input signal. Then, the input neuron 40 outputs the input state value to the input-intermediate synapse unit 26. Note that the input neuron 40 may output the value of the input signal as it is as the input state value.

The intermediate layer 24 acquires one or more intermediate input signals corresponding to the input signal via the input-intermediate synapse unit 26. The intermediate layer 24 generates plural intermediate signals based on the acquired one or more intermediate input signals.

The intermediate layer 24 includes N intermediate neurons 42 and plural intermediate synapses 44. N denotes an integer of 2 or more.

Each of the N intermediate neurons 42 stores a state value and outputs the state value. In the present embodiment, the state value represents a binary value of 0 or 1. Note that the state value may be a continuous value or a discrete value of two or more values.

The intermediate synapses 44 generate intermediate signals. The intermediate synapses 44 correspond to the intermediate signals generated in the intermediate layer 24 on one-to-one basis. Each of the intermediate synapses 44 generates a corresponding intermediate signal among the intermediate signals in accordance with the state value output from any one intermediate neuron 42 of the N intermediate neurons 42.

More specifically, an intermediate synaptic load is set for each of the intermediate synapses 44. The intermediate synaptic load is represented by either a positive real value, a negative real value, or zero. The intermediate synaptic load may be a continuous value or a discrete value of two or more values.

In each of the intermediate synapses 44, any one of the N intermediate neurons 42 is set as a preceding neuron, and any one of the N intermediate neurons 42 is set as a subsequent neuron. The preceding neuron and the subsequent neuron may be the same. Each of the intermediate synapses 44 outputs a signal obtained by multiplying a state value output from the preceding neuron which is any one of the N intermediate neurons 42 by a set intermediate synaptic load to the subsequent neuron which is any one of the N intermediate neurons 42 as a corresponding intermediate signal among the intermediate signals.

In the intermediate layer 24, the preceding neuron and the subsequent neuron connected to each of the intermediate synapses 44 are set so as to constitute a recurrent neural network. That is, at least one intermediate neuron 42 among the N intermediate neurons 42 feeds back an intermediate signal from another intermediate neuron 42 in which a state value output by the intermediate neuron is propagated via the one or more intermediate synapses 44.

In the present embodiment, the intermediate layer 24 includes (N×N) intermediate synapses 44 as the intermediate synapses 44. The (N×N) intermediate synapses 44 correspond to (N×N) combinations of the preceding neuron and the subsequent neuron, which are implemented by the N intermediate neurons 42.

In addition, at least some of the intermediate synapses 44 may update the set intermediate synaptic load with the lapse of time. For example, at least some of the intermediate synapses 44 may update the intermediate synaptic load in accordance with, for example, spike timing dependent plasticity (STDP). In addition, at least some of the intermediate synapses 44 may update the intermediate synaptic load in accordance with, for example, the Fusi rule (SDSP rule). Details of STDP and Fusi rule will be described later. In each of the intermediate synapses 44, the intermediate synaptic load is randomly set at the start or the like, and the intermediate synaptic load may not be updated after being set.

In the present embodiment, each of the N intermediate neurons 42 acquires at least one of one or more intermediate input signals output from the input-intermediate synapse unit 26 or intermediate signals generated by the intermediate synapses 44. Each of the N intermediate neurons 42 changes the state value with the lapse of time based on a predetermined update rule in accordance with at least one of the one or more intermediate input signals or the intermediate signals. Then, each of the N intermediate neurons 42 outputs the stored state value.

The input-intermediate synapse unit 26 includes one or more input-intermediate synapses 46. The one or more input-intermediate synapses 46 correspond to the one or more intermediate input signals output to the intermediate layer 24 on one-to-one basis. Each of the one or more input-intermediate synapses 46 has an input-intermediate synaptic load set thereon. The input-intermediate synaptic load is represented by either a positive real value, a negative real value, or zero. The input-intermediate synaptic load may be a continuous value or a discrete value of two or more values.

In each of the one or more input-intermediate synapses 46, the input neuron 40 is set as a preceding neuron, and any of the N intermediate neurons 42 included in the intermediate layer 24 is set as a subsequent neuron. Each of the one or more input-intermediate synapses 46 outputs a signal obtained by multiplying the input state value output from the preceding neuron by the set input-intermediate synaptic load to the subsequent neuron as a corresponding intermediate input signal among the one or more intermediate input signals.

In the present embodiment, the input-intermediate synapse unit 26 includes N input-intermediate synapses 46 as one or more input-intermediate synapses 46. The N input-intermediate synapses 46 correspond to the N intermediate neurons 42 on one-to-one basis. Each of the N input-intermediate synapses 46 outputs an intermediate input signal to a corresponding intermediate neuron 42 among the N intermediate neurons 42.

Here, in the present embodiment, each of the N intermediate neurons 42 changes the state value with the lapse of time in accordance with at least one of one or more intermediate input signals or intermediate signals and a homeostatic signal that changes the state value in the direction of the target value with the preset intensity.

More specifically, when the intermediate layer 24 performs digital processing, the N intermediate neurons 42 output state values defined by Equation (1) below.

$$X ( t ) = θ ( {W}^{( i n )} u ( t ) + {W}^{( res )} X ( t - 1 ) - {T}_{IP} ( t ) - {V}_{threshold} ) \qquad ( 1 )$$

t is an integer that increases every 1 and is an index representing time.

X(t) and X(t−1) represent a matrix of N rows and one column. X(t) includes N state values output from the N intermediate neurons 42 at time t. X(t−1) includes N state values output from the N intermediate neurons 42 at time (t−1). The state value of the n-th intermediate neuron 42 (n is 1 or more and N or less) among the N intermediate neurons 42 is included in the n-th row of X(t) and X(t−1).

W⁽ⁱⁿ⁾ represents a matrix of N rows and one column. W⁽ⁱⁿ⁾ includes N input-intermediate synaptic loads set at the N input-intermediate synapses 46. The input-intermediate synaptic load set to the input-intermediate synapse 46 in which the n-th intermediate neuron 42 among the N input-intermediate synapse 46 is the subsequent neuron is included in the n-th row of W⁽ⁱⁿ⁾.

u(t) represents an input signal at time t.

W^{(res)} represents a matrix of N rows and N columns. W^{(res)} includes (N×N) intermediate synaptic loads set for the (N×N) intermediate synapses 44. The m-th row and the n-th column of W^{(res)} include an intermediate synaptic load set to the intermediate synapse 44 in which the n-th intermediate neuron 42 among the N intermediate neurons 42 is set as a preceding neuron and the m-th intermediate neuron 42 is set as a subsequent neuron (m is an integer of 1 or more and N or less).

T_{IP}(t) represents a matrix of N rows and one column. The T_{IP}(t) includes the values of the N homeostatic signals used for the N intermediate neurons 42 at time t. The value of the homeostatic signal of the n-th intermediate neuron 42 is included in the n-th row of the T_{IP}(t).

V_{threshold} represents a predetermined real value.

θ(A) represents an activation function using A as an argument. In the present embodiment, the activation function is a step function. Note that the activation function may be a snake site function.

The homeostatic signal is represented by Equation (2) below.

$${T}_{IP} ( t ) = {T}_{IP} ( t - 1 ) + {η}_{IP} ( X ( t - 1 ) - {Target}_{IP} ) \qquad ( 2 )$$

The T_{IP}(t−1) includes the values of the N homeostatic signals at time (t−1).

Target_{IP} represents a matrix of N rows and one column. Target_{IP} includes N target values set for the N intermediate neurons 42. The target value of the n-th intermediate neuron 42 is included in the n-th row of Target_{IP} and is expressed as Target_{IP,n}.

η_{IP} represents a matrix of N rows and one column. η_{IP} represents N set intensities set to the N intermediate neurons 42. Each of the N set intensities is a real number. The preset intensity of the n-th intermediate neuron 42 is included in the n-th row of the η_{IP} and is expressed as η_{IP,n}.

Such a homeostatic signal functions to change the state value in the direction of the target value with a preset intensity with the lapse of time. For example, the homeostatic signal acts like a spring oscillating with a predetermined spring force (preset intensity) to position the object in a steady position (target value) relative to the state value.

Note that, in a case where the intermediate layer 24 processes analog signals, in a case where the intermediate layer 24 processes multivalued discrete values, or in a case where the intermediate layer 24 processes continuous digital signals, the N intermediate neurons 42 output state values defined by Equation (3) below.

$$X ( t ) = ( 1 - α ) X ( t - 1 ) + α tanh ( {W}^{( i n )} u ( t ) + {W}^{( res )} ( t - 1 ) - {T}_{IP} ( t ) ) \qquad ( 3 )$$

α represents a leakage rate, and is a real number value larger than 0 and smaller than 1. tanh(A) is an activation function using A as an argument, and is a hyperbolic tangent function. Note that Equation (3) may be another function such as a sigmoid function, a ReLU function, a Softmax function, or an identity function, instead of the hyperbolic tangent function.

As described above, in the present embodiment, each of the N intermediate neurons 42 generates an internal state value based on at least one of the one or more intermediate input signals or the intermediate signals and the homeostatic signal, and generates a state value by giving the internal state value to the activation function. In each of the N intermediate neurons 42, since the homeostatic signal changes the state value in the direction of the target value with the preset intensity, for example, even if the input signal is constant, the state value can be changed with the lapse of time.

Furthermore, in the present embodiment, the N intermediate neurons 42 include P types having different predetermined update rules. P is an integer of 2 or more and N or less. That is, each of the N intermediate neurons 42 is any one of the P types.

In the present embodiment, the update rule in each of the N intermediate neurons 42 corresponds to an arithmetic expression of the homeostatic signal. More specifically, in the present embodiment, each of the P types of intermediate neurons 42 has a homeostatic signal different from that of the other types of intermediate neurons 42. More specifically, for example, each of the P types of intermediate neurons 42 is different from the other types of intermediate neurons 42 in the value of η_{IP} as the adjustment intensity or Target_{IP} as the target value in Equation (3).

η_{IP} which is the adjustment intensity may be 0. However, in a case where η_{IP} that is the adjustment intensity is 0, the value of the homeostatic signal is 0 regardless of the value of Target_{IP} that is the target value. Therefore, when η_{IP} that is the adjustment intensity is 0, the homeostatic signal is the same regardless of the value of Target_{IP} that is the target value.

For example, the example of FIG. 1 illustrates a case where P=3. In the example of FIG. 1, each of the N intermediate neurons 42 is one of the first type, the second type, and the third type. The first type of intermediate neuron 42 (IP1) has a target value Target_{IP,1} of −0.1 and an adjustment intensity η_{IP,1} of 10⁻⁴. The second type of intermediate neuron 42 (IP2) has a target value Target_{IP,2} of 1 and an adjustment intensity η_{IP,2} of 10⁻⁴. The third type of intermediate neuron 42 (IP3) has a target value Target_{IP,3} of 1 and an adjustment intensity η_{IP,3} of 10⁻⁵.

Even in a case where the same signal is input and the same state value is stored, each of the P types of intermediate neurons 42 can output a state value different from the other types when the state value is changed with the lapse of time.

The output layer 28 acquires the intermediate output signals via the intermediate-output synapse unit 30. Each of the intermediate output signals is a signal corresponding to a state value output by any intermediate neuron 42 of the N intermediate neurons 42, which is acquired via the intermediate-output synapse unit 30. Then, the output layer 28 outputs an output signal corresponding to the intermediate output signals.

In the example of FIG. 1, the output layer 28 acquires N intermediate output signals corresponding to the N state values output from the N intermediate neurons 42 as the intermediate output signals. That is, the N intermediate output signals correspond to the N intermediate neurons 42 on one-to-one basis. Therefore, each of the N intermediate output signals is a signal corresponding to the state value output from the corresponding intermediate neuron 42 among the N intermediate neurons 42.

The output layer 28 includes P output neurons 50, plural output synapses 52, and a final output neuron 54.

The P output neurons 50 correspond to the P types of intermediate neurons 42 included in the N intermediate neurons 42 on one-to-one basis. In the example of FIG. 1, the output layer 28 includes, as the P output neurons 50, a first output neuron 50-1, a second output neuron 50-2, and a third output neuron 50-3. The first output neuron 50-1 corresponds to the first type intermediate neuron 42 (IP1). The second output neuron 50-2 corresponds to the second type intermediate neuron 42 (IP2). The third output neuron 50-3 corresponds to the third type intermediate neuron 42 (IP3).

Each of the P output neurons 50 outputs a combined signal representing an output state value obtained by linearly combining respective state values of one or more intermediate neurons 42 of a corresponding type among the N intermediate neurons 42. The output state value is represented by a real number.

More specifically, each of the P output neurons 50 acquires one or more intermediate output signals corresponding to the state value output from each of one or more intermediate neurons 42 of the corresponding type among the N intermediate neurons 42 via the intermediate-output synapse unit 30. Each of the P output neurons 50 changes the output state value with the lapse of time in accordance with the acquired one or more intermediate output signals. For example, each of the P output neurons 50 sets a value obtained by adding the acquired one or more intermediate output signals as an output state value. Then, each of the P output neurons 50 outputs a combined signal representing an output state value.

For example, in the example of FIG. 1, the first output neuron 50-1 outputs a first combined signal obtained by linearly combining the state values output from each of the one or more intermediate neurons 42 (IP1) of the first type. The second output neuron 50-2 outputs a second combined signal obtained by linearly combining the state values output from each of the one or more intermediate neurons 42 (IP2) of the second type. The third output neuron 50-3 outputs a third combined signal obtained by linearly combining the state values output from each of the one or more intermediate neurons 42 (IP3) of the third type.

The output synapses 52 correspond to any of the P output neurons 50. An output synaptic load is set for each of the P output synapses 52. The output synaptic load is expressed as a positive real value or a negative real value. In addition, the output synaptic load may be a signed continuous value or a signed discrete value of two or more values. Each of the output synapses 52 outputs a signal obtained by multiplying the combined signal output from the corresponding output neuron 50 among the P output neurons 50 by a preset output synaptic load.

In the present embodiment, the output layer 28 includes P output synapses 52 as the output synapses 52. In each of the P output synapses 52, the corresponding output neuron 50 among the P output neurons 50 is set as a preceding neuron, and the final output neuron 54 is set as a subsequent neuron. Then, each of the P output synapses 52 outputs a signal obtained by multiplying the combined signal output from the preceding neuron by the set output synaptic load to the subsequent neuron.

For example, in the example of FIG. 1, the output layer 28 includes, as the P output synapses 52, a first output synapse 52-1, a second output synapse 52-2, and a third output synapse 52-3. The first output synapse 52-1 outputs a signal obtained by multiplying the first combined signal output from the first output neuron 50-1 by the set output synaptic load to the final output neuron 54 which is the subsequent neuron. The second output synapse 52-2 outputs a signal obtained by multiplying the second combined signal output from the second output neuron 50-2 by the set output synaptic load to the final output neuron 54 which is the subsequent neuron. The third output synapse 52-3 outputs a signal obtained by multiplying the third combined signal output from the third output neuron 50-3 by the set output synaptic load to the final output neuron 54 which is the subsequent neuron.

Here, the first output synapse 52-1, which is any one output synapse 52 among the output synapses 52, outputs a signal obtained by inverting a positive/negative sign of the first combined signal output from the first output neuron 50-1 by multiplying the set output synaptic load.

In addition, any second output synapse 52-2 different from the first output synapse 52-1 among the output synapses 52 outputs a signal that does not invert the positive/negative sign of the second combined signal output from the second output neuron 50-2.

That is, the output synaptic load set to the first output synapse 52-1 and the output synaptic load set to the second output synapse 52-2 are represented by real numbers with inverted signs. Note that the absolute value of the output synaptic load set to the first output synapse 52-1 and the absolute value of the output synaptic load set to the second output synapse 52-2 may be the same or different.

In addition, the output synapses 52 other than the first output synapse 52-1 and the second output synapse 52-2 among the output synapses 52 may or may not invert the positive/negative sign of the combined signal output from the corresponding output neuron 50.

The final output neuron 54 adds the signals output from each of the output synapses 52 to generate an output signal, and outputs the generated output signal. That is, the final output neuron 54 generates and outputs an output signal by linearly combining the combined signals output from the respective P output neurons 50.

Note that the final output neuron 54 may output an output signal obtained by further performing activation function calculation on a value obtained by adding the signals output from each of the output synapses 52. In addition, the final output neuron 54 may output an output signal obtained by binarizing a value obtained by adding the signals output from each of the output synapses 52 or a value obtained by performing the activation function calculation with a preset threshold.

The intermediate-output synapse unit 30 includes a plurality of intermediate-output synapses 56. The intermediate-output synapses 56 correspond to the intermediate output signals output from the intermediate layer 24 to the output layer 28 on one-to-one basis.

Each of the intermediate-output synapses 56 acquires a state value output from any of the N intermediate neurons 42 among the intermediate neurons 42. An intermediate-output synaptic load is set for each of the intermediate-output synapses 56. The intermediate-output synaptic load is expressed as either a positive real value, a negative real value, or zero. The intermediate-output synaptic load may be a continuous value or a discrete value of two or more values.

Each of the intermediate-output synapses 56 outputs a signal obtained by multiplying the state value output from the preceding neuron which is any one of the N intermediate neurons 42 by the set intermediate-output synaptic load as a corresponding intermediate output signal among the intermediate output signals. Further, each of the intermediate-output synapses 56 outputs a corresponding intermediate output signal to the output neuron 50 corresponding to the type of the preceding neuron among the P output neurons 50.

More specifically, in each of the intermediate-output synapses 56, any intermediate neuron 42 among the N intermediate neurons 42 is set as a preceding neuron, and an output neuron 50 corresponding to the type of the preceding neuron among the P output neurons 50 is set as a subsequent neuron. For example, in the example of FIG. 1, in the intermediate-output synapse 56 in which the first type of intermediate neuron 42 (IP1) is set as the preceding neuron, the first output neuron 50-1 is set as the subsequent neuron. In the intermediate-output synapse 56 in which the second type intermediate neuron 42 (IP2) is set as the preceding neuron, the second output neuron 50-2 is set as the subsequent neuron. In the intermediate-output synapse 56 in which the third type intermediate neuron 42 (IP3) is set as the preceding neuron, the third output neuron 50-3 is set as the subsequent neuron. Then, each of the intermediate-output synapses 56 outputs a signal obtained by multiplying the state value output from the preceding neuron by the set intermediate-output synaptic load to the subsequent neuron as a corresponding intermediate output signal among the intermediate output signals.

In the present embodiment, the intermediate-output synapse unit 30 includes N intermediate-output synapses 56 corresponding to the N intermediate neurons 42 as the intermediate-output synapses 56 on one-to-one basis. Each of the N intermediate-output synapses 56 has the corresponding intermediate neuron 42 among the N intermediate neurons 42 as a preceding neuron.

Here, the intermediate-output synaptic load set for each of the intermediate-output synapses 56 is set to an optimum value in advance by learning. The intermediate-output synaptic load set to each of the intermediate-output synapses 56 is learned such that, when a normal input signal is input, the combined signal output from each of the P output neurons 50 is a signal after a preset time in the normal input signal, for example, a signal after a t_{pred} time step of the input normal input signal.

Furthermore, the intermediate-output synaptic load set to each of the intermediate-output synapses 56 may be learned such that, when a normal input signal is input, a difference signal representing a difference between a combined signal output from each of the P output neurons 50 and a signal after a preset time in the normal input signal becomes 0.

The intermediate-output synaptic load is set to an optimum value by updating by linear regression, ridge regression, gradient descent or stochastic gradient descent. Note that t_{pred} is an integer and represents a time corresponding to t shown in Equations (1) and (2).

The signal processing device 10 according to the first embodiment as described above can output an output signal obtained by predicting a normal input signal after a preset time from each of the P output neurons 50.

Furthermore, in the signal processing device 10 according to the first embodiment, the intermediate layer 24 includes the P types of intermediate neurons 42, and the output layer 28 generates a combined signal obtained by linearly combining the state values output from the intermediate neurons 42 for each of the P types. Then, in the signal processing device 10, the output layer 28 inverts the positive/negative sign of the first combined signal corresponding to the first type among the P types, and outputs the linearly combined output signal without inverting the positive/negative sign of the second combined signal corresponding to the second type among the P types.

With the above-described configuration, the signal processing device 10 according to the first embodiment can generate P types of combined signals having different responses to abnormal components due to the difference in the state values accompanying the type differences among the P types of intermediate neurons 42. Then, the signal processing device 10 inverts the positive/negative sign of the first combined signal among the P types of combined signals and generates an output signal obtained by linearly combining the positive/negative sign of the second combined signal without inverting the positive/negative sign of the second combined signal, thereby removing a common component such as noise and outputting an output signal in which the abnormal component is emphasized.

The signal processing device 10 according to the first embodiment can execute signal processing in a state including noise without performing spectrum analysis on the input signal by the digital processing circuit. As a result, the signal processing device 10 can detect, for example, an abnormality in time-series data measured by a medical device that continues to operate, infrastructure equipment, or the like, in a terminal device with low processing capability provided in the vicinity of the medical device, infrastructure equipment, or the like.

### Second Embodiment

Next, a signal processing device 10 according to a second embodiment will be described. In the second embodiment, components having substantially the same functions and configurations as those of the components described in the first embodiment are denoted by the same reference numerals, and detailed description thereof is omitted except for differences. The same applies to the third and subsequent embodiments.

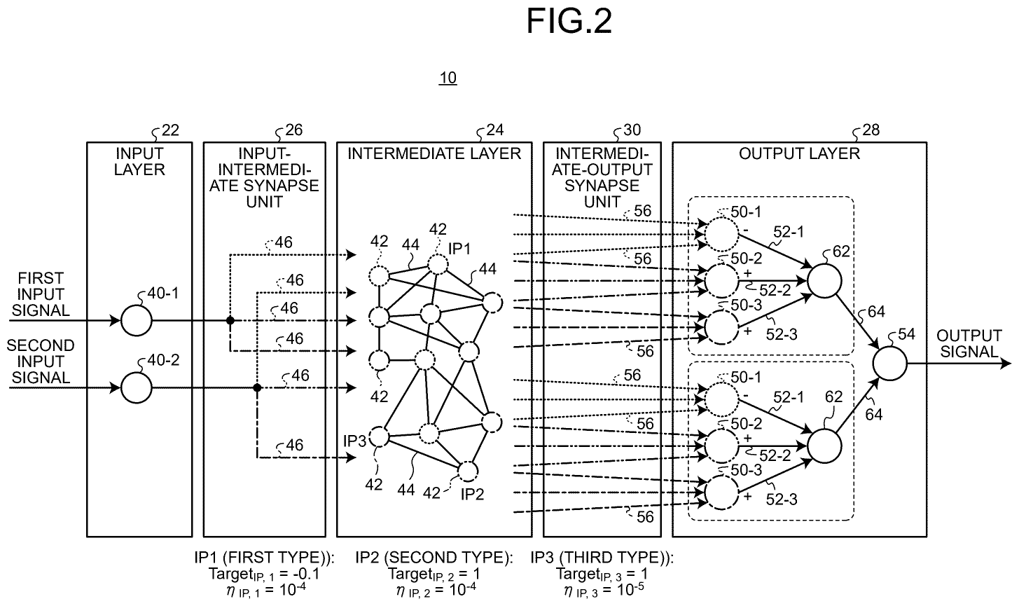

FIG. 2 is a diagram illustrating a configuration of a signal processing device 10 according to a second embodiment.

The signal processing device 10 according to the second embodiment acquires M input signals in time series, and outputs an output signal representing an abnormal component included in the M input signals. M is an integer of 1 or more. In the example of FIG. 2, the signal processing device 10 acquires a time-series first input signal and a time-series second input signal.

The input layer 22 acquires M input signals. The input layer 22 includes M input neurons 40. The M input neurons 40 correspond to the M input signals on one-to-one basis. Each of the M input neurons 40 acquires a corresponding input signal among the M input signals. In the example of FIG. 2, the input layer 22 includes, as the M input neurons 40, a first input neuron 40-1 that acquires the first input signal and a second input neuron 40-2 that acquires the second input signal. Then, each of the M input neurons 40 outputs an input state value corresponding to the corresponding input signal.

The intermediate layer 24 acquires one or more intermediate input signals corresponding to the M input signals via the input-intermediate synapse unit 26. The intermediate layer 24 generates intermediate signals based on the acquired one or more intermediate input signals.

In the present embodiment, the input-intermediate synapse unit 26 includes N input-intermediate synapses 46 for each of the M input neurons 40 as one or more input-intermediate synapses 46. That is, in the present embodiment, the input-intermediate synapse unit 26 includes (M×N) input-intermediate synapses 46.

In the example of FIG. 2, the N input-intermediate synapses 46 having the first input neuron 40-1 as the preceding neuron correspond to the N intermediate neurons 42 on one-to-one basis. The N input-intermediate synapses 46 having the second input neuron 40-2 as the preceding neuron correspond to the N intermediate neurons 42 on one-to-one basis.

The output layer 28 includes (M×P) output neurons 50, M group final neurons 62, (M×P) output synapses 52, M final output synapses 64, and final output neurons 54.

The (M×P) output neurons 50 are grouped into M groups. The M groups correspond to the M input signals on one-to-one basis. In the example of FIG. 2, the (M×P) output neurons 50 are grouped into two groups of a first group corresponding to a first input signal and a second group corresponding to a second input signal.

Each of the M groups includes P output neurons 50. The P output neurons 50 included in each of the M groups correspond to the P types of intermediate neurons 42 included in the N intermediate neurons 42 on one-to-one basis.

In the example of FIG. 2, each of the M groups includes, as the P output neurons 50, the first output neuron 50-1, the second output neuron 50-2, and the third output neuron 50-3. The first output neuron 50-1 corresponds to the first type intermediate neuron 42 (IP1). The second output neuron 50-2 corresponds to the second type intermediate neuron 42 (IP2). The third output neuron 50-3 corresponds to the third type intermediate neuron 42 (IP3).

The (M×P) output synapses 52 correspond to the (M×P) output neurons 50 on one-to-one basis. The (M×P) output synapses 52 correspond to the (M×P) output neurons 50, and are grouped into M groups each including P output synapses 52.

In each of the (M×P) output synapses 52, the corresponding output neuron 50 among the (M×P) output neurons 50 is set as a preceding neuron, and the group final neuron 62 grouped into the same group as the preceding neuron among the M group final neurons 62 is set as a subsequent neuron. Each of the (M×P) output synapses 52 outputs a signal obtained by multiplying the combined signal output from the preceding neuron by the set output synaptic load to the subsequent neuron.

Here, the first output synapse 52-1 included in each of the M groups outputs a signal obtained by inverting the positive/negative sign of the first combined signal output from the first output neuron 50-1 by multiplying the set output synaptic load. Note that the first output synapse 52-1 included in each of the M groups is any one of the output synapses 52 among the P output synapses 52 included in the corresponding group.

In addition, the second output synapse 52-2 included in each of the M groups outputs a signal that does not invert the positive/negative sign of the second combined signal output from the second output neuron 50-2 by multiplying the set output synaptic load. Note that the second output synapse 52-2 included in each of the M groups is any one output synapse 52 different from the first output synapse 52-1 among the P output synapses 52 included in the corresponding group.

That is, for each of the M groups, the output synaptic load set to the first output synapse 52-1 and the output synaptic load set to the second output synapse 52-2 are represented by real numbers with inverted signs.

In addition, the output synapses 52 other than the first output synapse 52-1 and the second output synapse 52-2 among the P output synapses 52 included in each of the M groups may or may not invert the positive/negative sign of the combined signal output from the corresponding output neuron 50.

The M group final neurons 62 correspond to the (M×P) output neurons 50 and correspond to the M groups on one-to-one basis. Each of the M group final neurons 62 acquires a combined signal output from each of the P output synapses 52 included in the same group. Then, each of the M group final neurons 62 adds the combined signals output from each of the P output synapses 52 included in the same group to generate an intermediate output value, and outputs the generated intermediate output value. That is, each of the M group final neurons 62 generates and outputs an intermediate output value by linearly combining the combined signals output from each of the P output neurons 50 included in the same group.

The M final output synapses 64 correspond to the M group final neurons 62 on one-to-one basis. An intermediate output synaptic load is set for each of the M final output synapses 64. The intermediate output synaptic load is represented by a positive real value or a negative real value. In each of the M final output synapses 64, the corresponding group final neuron 62 among the M group final neurons 62 is set as a preceding neuron, and the final output neuron 54 is set as a subsequent neuron. Each of the M final output synapses 64 outputs a signal obtained by multiplying the intermediate output value output from the preceding neuron by the set intermediate output synaptic load to the subsequent neuron.

The final output neuron 54 adds the signals output from each of the M final output synapses 64 to generate an output signal, and outputs the generated output signal. That is, the final output neuron 54 generates an output signal by linearly combining the combined signals output from each of the (M×P) output neurons 50. Note that the final output neuron 54 may output an output signal obtained by further performing activation function calculation on a value obtained by adding the signals output from each of the M final output synapses 64. In addition, the final output neuron 54 may output an output signal obtained by further binarizing a value obtained by adding the signals output from each of the M final output synapses 64 or a value obtained by performing the activation function calculation with a preset threshold.

In the present embodiment, the intermediate-output synapse unit 30 includes (M×N) intermediate-output synapses 56. The (M×N) intermediate-output synapses 56 are correlated with the (M×P) output neurons 50, and are grouped into M groups each including N intermediate-output synapses 56. The N intermediate-output synapses 56 in each of the M groups correspond to the N intermediate neurons 42 on one-to-one basis. In each of the N intermediate-output synapses 56 in one group, the corresponding intermediate neuron 42 among the N intermediate neurons 42 is set as the preceding neuron. N intermediate-output synapses 56 in a group correspond to N output neurons 50 in a corresponding group of (M×P) output neurons 50 on one-to-one basis. In each of the N intermediate-output synapses 56 in one group, the corresponding output neuron 50 among the N output neurons 50 included in the corresponding group is set as a subsequent neuron.

Here, the intermediate-output synaptic load set for each of the (M×N) intermediate-output synapses 56 is set to an optimum value in advance by learning. The intermediate-output synaptic load set at each of the (M×N) intermediate-output synapses 56 is learned such that, when M normal input signals are input, for each of the M groups, a combined signal output from each of the P output neurons 50 is a signal after a preset time in a corresponding normal input signal among the M normal input signals, that is, a signal after, for example, a t_{pred} time step of the corresponding normal input signal.

Furthermore, the intermediate-output synaptic load set to each of the intermediate-output synapses 56 may be learned such that, when M normal input signals are input, for each of the M groups, a difference signal representing a difference between a combined signal output from each of the P output neurons 50 and a signal after a preset time in a corresponding normal input signal among the M normal input signals becomes 0.

The signal processing device 10 according to the second embodiment as described above can output an output signal obtained by predicting M normal input signals after a preset time from each of the P output neurons 50.

Furthermore, in the signal processing device 10 according to the second embodiment, the intermediate layer 24 includes the P types of intermediate neurons 42, and the output layer 28 generates, for each of the M groups corresponding to the M input signals, a combined signal obtained by linearly combining the state values output from the intermediate neurons 42 for each of the P types. Then, in the signal processing device 10, for each of the M groups, the output layer 28 inverts the positive/negative sign of the first combined signal corresponding to the first type among the P types and outputs the linearly combined output signal without inverting the positive/negative sign of the second combined signal corresponding to the second type among the P types.

As a result, the signal processing device 10 according to the second embodiment can generate, for each of the M groups, P types of combined signals having different responses to abnormal components due to the difference in the state values accompanying the type differences among the P types of intermediate neurons 42. Then, the signal processing device 10, for each of the M groups, inverts the positive/negative sign of the first combined signal among the P types of combined signals and generates, an output signal obtained by linearly combining the positive/negative sign of the second combined signal without inverting the positive/negative sign of the second combined signal, thereby removing a common component such as noise and outputting an output signal in which the abnormal component is emphasized.

The signal processing device 10 according to the second embodiment can execute signal processing in a state including noise without performing spectrum analysis on the input signal by the digital processing circuit, similarly to the first embodiment. As a result, the signal processing device 10 can detect, for example, an abnormality in time-series data measured by a medical device that continues to operate, infrastructure equipment, or the like, in a terminal device with low processing capability provided in the vicinity of the medical device, infrastructure equipment, or the like.

### Third Embodiment

Next, a signal processing device 10 according to a third embodiment will be described.

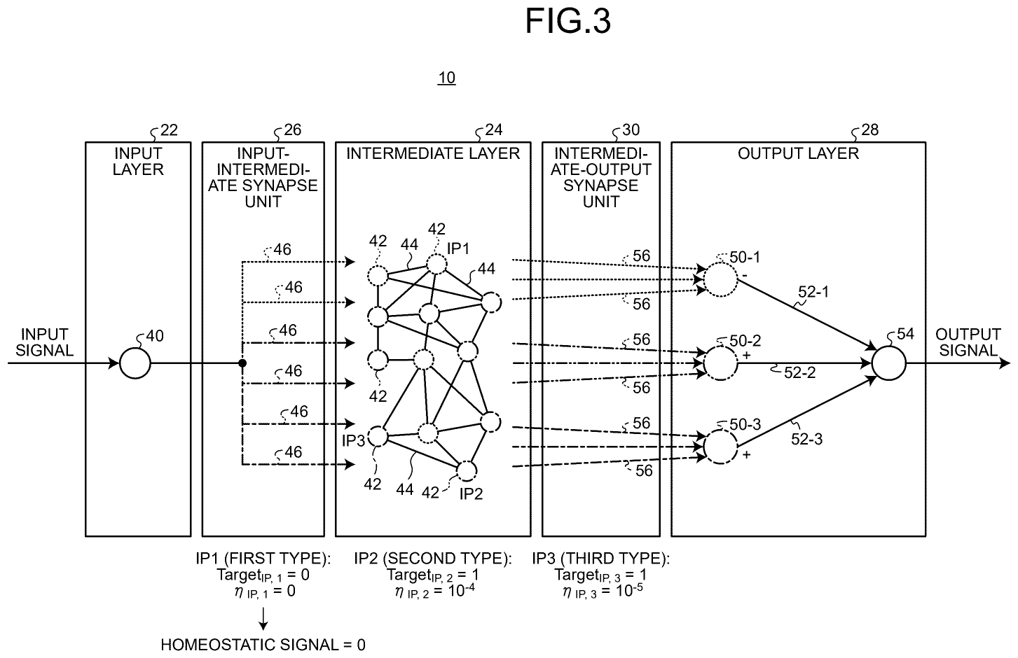

FIG. 3 is a diagram illustrating a configuration of the signal processing device 10 according to the third embodiment. In the N intermediate neurons 42 according to the third embodiment, the homeostatic signal in any one type of the P types of intermediate neurons 42 is 0.

For example, in the intermediate neuron 42 of a type in which the homeostatic signal is 0, the value of the corresponding row of η_{IP} in Equation (2) is set to 0. Note that the intermediate neuron 42 of the type in which the homeostatic signal is 0 may have any value in the corresponding row of Target_{IP} in Equation (2).

That is, when the intermediate layer 24 performs digital processing, the value of the corresponding row of the T_{IP}(t) in the Equation (1) is set to 0 for the intermediate neuron 42 of a type in which the homeostatic signal is 0. Further, when the intermediate layer 24 performs processing of analog signals, the value of the corresponding row of the T_{IP}(t) in the Equation (3) is set to 0 for the intermediate neuron 42 of a type in which the homeostatic signal is 0.

Note that P is 3 in FIG. 3, but may be 4 or more. While FIG. 3 illustrates an example in which one input signal is input, two or more input signals may be input to the signal processing device 10 according to the third embodiment. In this case, the output layer 28 includes P output neurons 50 and P output synapses 52 for each of the M groups corresponding to the M input signals. Then, the P output neurons 50 and the P output synapses 52 included in each of the M groups operate similarly to a case where one input signal is input.

### Fourth Embodiment

Next, a signal processing device 10 according to a fourth embodiment will be described.

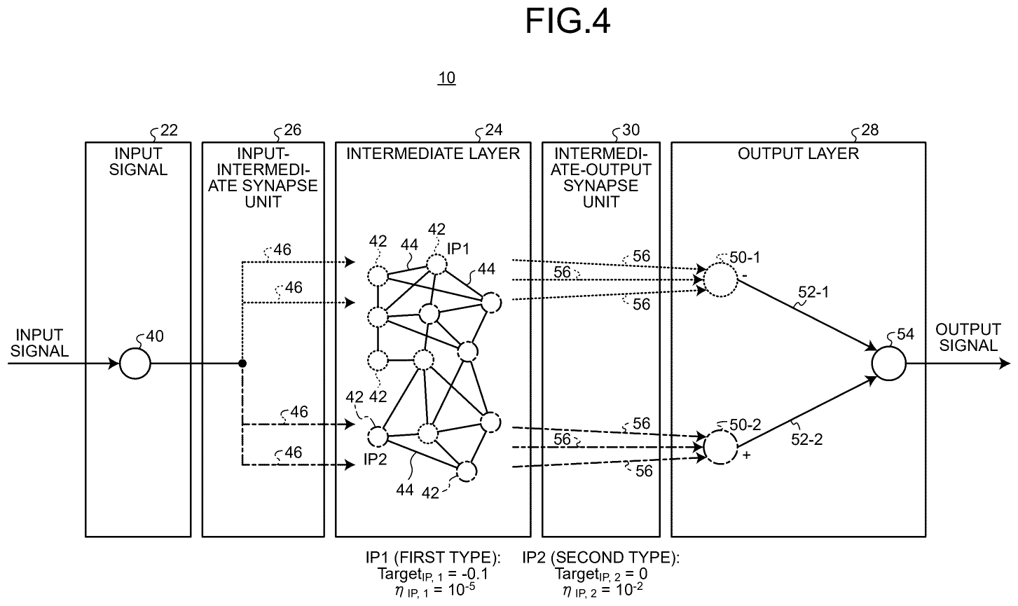

FIG. 4 is a diagram illustrating a configuration of the signal processing device 10 according to the fourth embodiment. The signal processing device 10 according to the fourth embodiment has a configuration in a case of P=2. Therefore, the N intermediate neurons 42 include two types of intermediate neurons 42 as the P types of intermediate neurons 42. In addition, the output layer 28 according to the fourth embodiment includes two output neurons 50 as the P output neurons 50, and includes two output synapses 52 as the P output synapses 52. In this case, the first output synapse 52-1, which is one of the two output synapses 52, outputs a signal obtained by inverting the positive/negative sign of the first combined signal output from the first output neuron 50-1. In addition, the second output synapse 52-2 different from the first output synapse 52-1 among the two output synapses 52 outputs a signal that does not invert the positive/negative sign of the second combined signal output from the second output neuron 50-2.

While FIG. 4 illustrates an example in which one input signal is input, two or more input signals may be input to the signal processing device 10 according to the fourth embodiment. In this case, the output layer 28 includes two output neurons 50 and two output synapses 52 for each of the M groups corresponding to the M input signals. Then, the two output neurons 50 and the two output synapses 52 included in each of the M groups operate similarly to a case where one input signal is input.

### Fifth Embodiment

Next, a signal processing device 10 according to a fifth embodiment will be described.

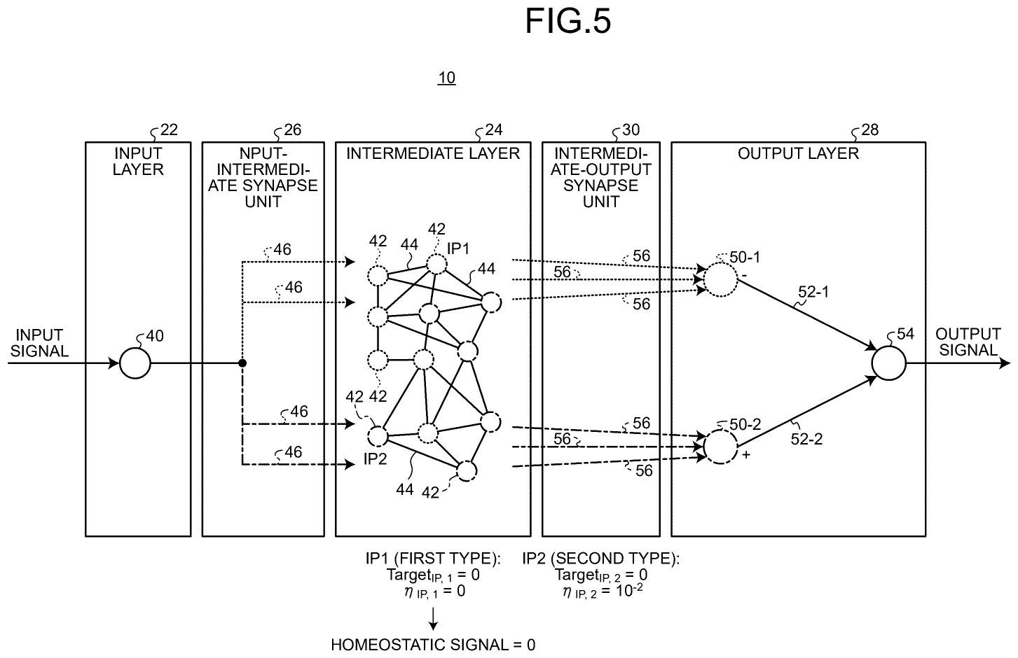

FIG. 5 is a diagram illustrating a configuration of the signal processing device 10 according to the fifth embodiment. The signal processing device 10 according to the fifth embodiment has a configuration in a case of P=2. Furthermore, in the N intermediate neurons 42 according to the fifth embodiment, the homeostatic signal in one (first type) intermediate neuron 42 of the two types of intermediate neurons 42 is 0, and the homeostatic signal in the other (second type) intermediate neuron 42 changes with the lapse of time.

For example, in the first type intermediate neuron 42, the value of the corresponding row of η_{IP} in Equation (2) is set to 0. In the second type intermediate neurons 42, a real number other than 0 is set as the value of the corresponding row of η_{IP} in the Equation (2), and an optional real number is set as the value of the corresponding row of Target_{IP}.

In addition, the output layer 28 according to the fifth embodiment includes two output neurons 50 as the P output neurons 50, and includes two output synapses 52 as the P output synapses 52, similarly to the third embodiment.

While FIG. 5 illustrates an example in which one input signal is input, M input signals may be input to the signal processing device 10 according to the fifth embodiment. In this case, the output layer 28 includes two output neurons 50 and two output synapses 52 for each of the M groups corresponding to the M input signals. Then, the two output neurons 50 and the two output synapses 52 included in each of the M groups operate similarly to a case where one input signal is input.

### Sixth Embodiment

Next, a signal processing device 10 according to a sixth embodiment will be described.

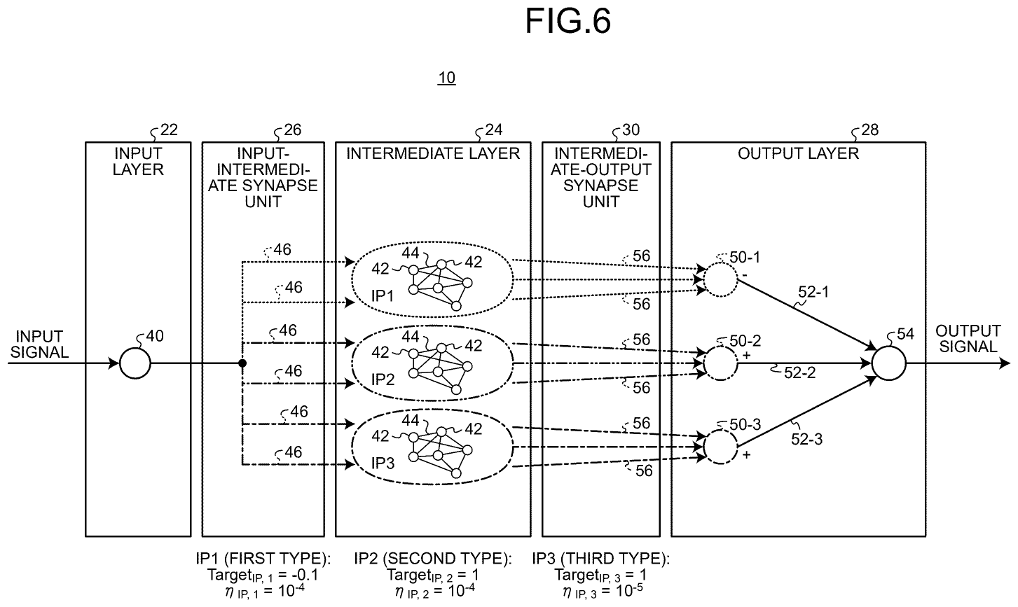

FIG. 6 is a diagram illustrating a configuration of the signal processing device 10 according to the sixth embodiment. In the intermediate layer 24 according to the sixth embodiment, N intermediate neurons 42 independently constitute a recurrent neural network for each type. Therefore, each of the N intermediate neurons 42 according to the sixth embodiment changes the state value with the lapse of time in accordance with at least one of one or more intermediate input signals or one or more intermediate signals for which the intermediate neuron 42 of the same type among the intermediate signals is set as the preceding neuron. That is, each of the N intermediate neurons 42 according to the sixth embodiment does not acquire the intermediate signal from the intermediate synapse 44 having the intermediate neuron 42 of a type different from its own type as the preceding neuron.

For example, among the (N×N) intermediate synapses 44, the intermediate synapse 44 in which the type of the preceding neuron and the type of the subsequent neuron are different is not updated because the intermediate synaptic load is fixed to 0. As a result, the (N×N) intermediate synapses 44 do not transmit the intermediate signal to the subsequent neuron of a type different from that of the preceding neuron, and the N intermediate neurons 42 can independently form the recurrent neural network for each type.

Note that P is 3 in FIG. 6, but may be 4 or more. While FIG. 6 illustrates an example in which one input signal is input, M input signals may be input to the signal processing device 10 according to the sixth embodiment. In this case, the output layer 28 includes P output neurons 50 and P output synapses 52 for each of the M groups corresponding to the M input signals. Then, the P output neurons 50 and the P output synapses 52 included in each of the M groups operate similarly to a case where one input signal is input.

### Seventh Embodiment

Next, a signal processing device 10 according to a seventh embodiment will be described. In the seventh embodiment, components having substantially the same functions and configurations as those of the components described in the sixth embodiment are denoted by the same reference numerals, and detailed description thereof is omitted except for differences. The same applies to the eighth embodiment and the ninth embodiment.

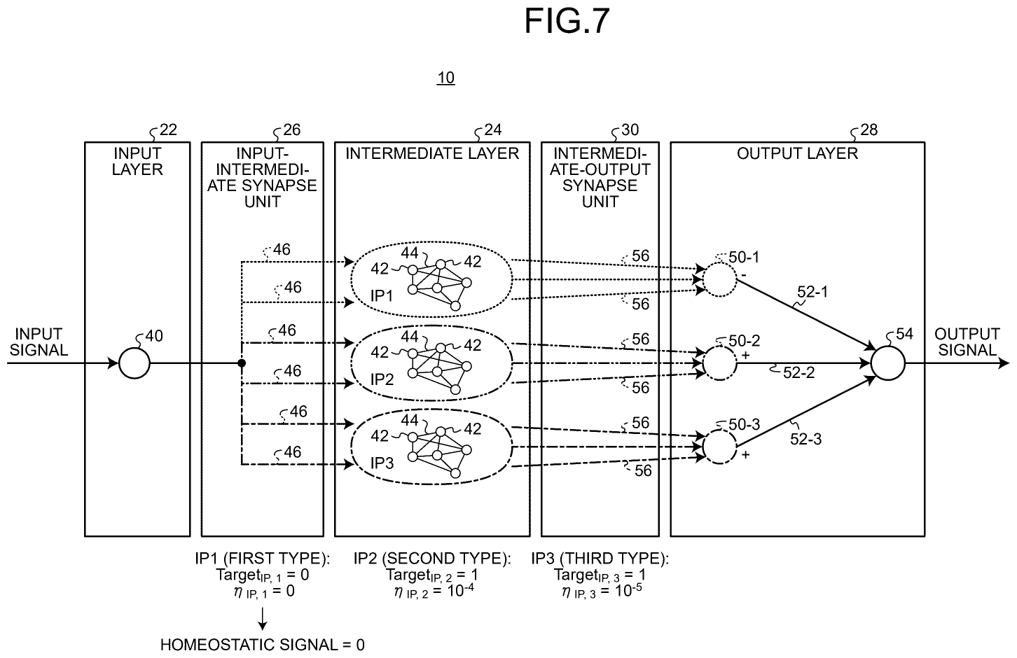

FIG. 7 is a diagram illustrating a configuration of the signal processing device 10 according to the seventh embodiment. In the N intermediate neurons 42 according to the seventh embodiment, the homeostatic signal in any one type of the P types of intermediate neurons 42 is 0.

For example, in the intermediate neuron 42 of a type in which the homeostatic signal is 0, the value of the corresponding row of η_{IP} in Equation (2) is set to 0. The intermediate neuron 42 of the type in which the homeostatic signal is 0 may have any value in the corresponding row of Target_{IP} in Equation (2).

That is, when the intermediate layer 24 performs digital processing, the value of the corresponding row of the T_{IP}(t) in the Equation (1) is set to 0 for the intermediate neuron 42 of a type in which the homeostatic signal is 0. Further, when the intermediate layer 24 performs processing of analog signals, the value of the corresponding row of the T_{IP}(t) in the Equation (3) is set to 0 for the intermediate neuron 42 of a type in which the homeostatic signal is 0.

Note that P is 3 in FIG. 7, but may be 4 or more. While FIG. 7 illustrates an example in which one input signal is input, two or more input signals may be input to the signal processing device 10 according to the seventh embodiment. In this case, the output layer 28 includes P output neurons 50 and P output synapses 52 for each of the M groups corresponding to the M input signals. Then, the P output neurons 50 and the P output synapses 52 included in each of the M groups operate similarly to a case where one input signal is input.

### Eighth Embodiment

Next, a signal processing device 10 according to an eighth embodiment will be described.

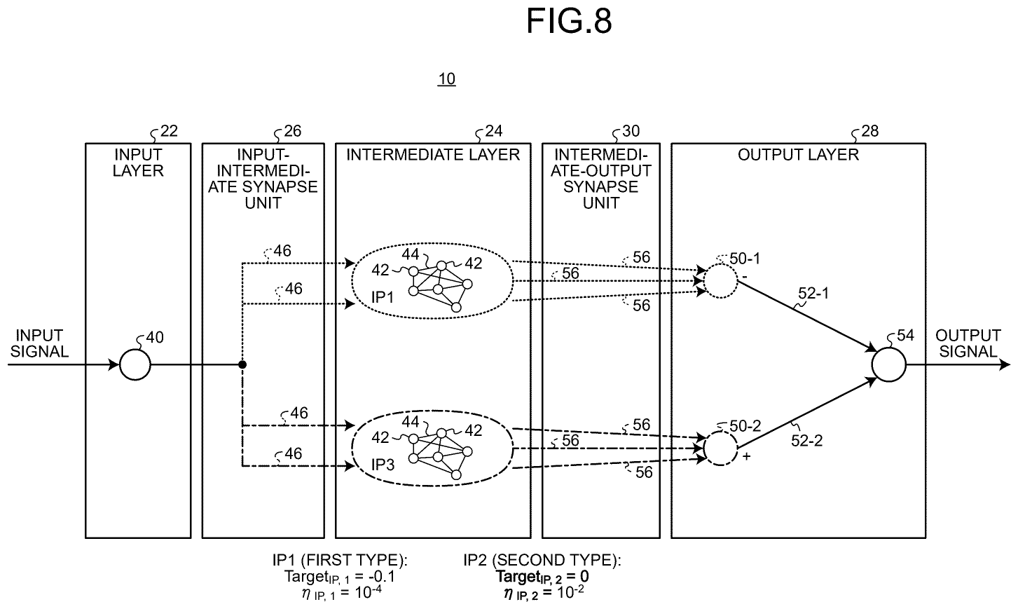

FIG. 8 is a diagram illustrating a configuration of the signal processing device 10 according to the eighth embodiment. The signal processing device 10 according to the eighth embodiment has a configuration in a case of P=2. Furthermore, in the N intermediate neurons 42 according to the eighth embodiment, both of the homeostatic signal in one (first type) intermediate neuron 42 of the two types of intermediate neurons 42 and the homeostatic signal in the other (second type) intermediate neuron 42 change with the lapse of time.

For example, in the first type intermediate neuron 42, the value of the corresponding row of η_{IP} in Equation (2) is set to 10⁻⁴, and the value of the corresponding row of Target is set to −0.1. Further, in the second-type intermediate neurons 42, the value of the corresponding row of η_{IP} in the Equation (2) is set to 10⁻², and the value of the corresponding row of Target_{IP} is set to 0.

In addition, the output layer 28 according to the eighth embodiment includes two output neurons 50 as the P output neurons 50, and includes two output synapses 52 as the P output synapses 52, similarly to the seventh embodiment.

While FIG. 8 illustrates an example in which one input signal is input, M input signals may be input to the signal processing device 10 according to the eighth embodiment. In this case, the output layer 28 includes two output neurons 50 and two output synapses 52 for each of the M groups corresponding to the M input signals. Then, the two output neurons 50 and the two output synapses 52 included in each of the M groups operate similarly to a case where one input signal is input.

### Ninth Embodiment

Next, a signal processing device 10 according to a ninth embodiment will be described.

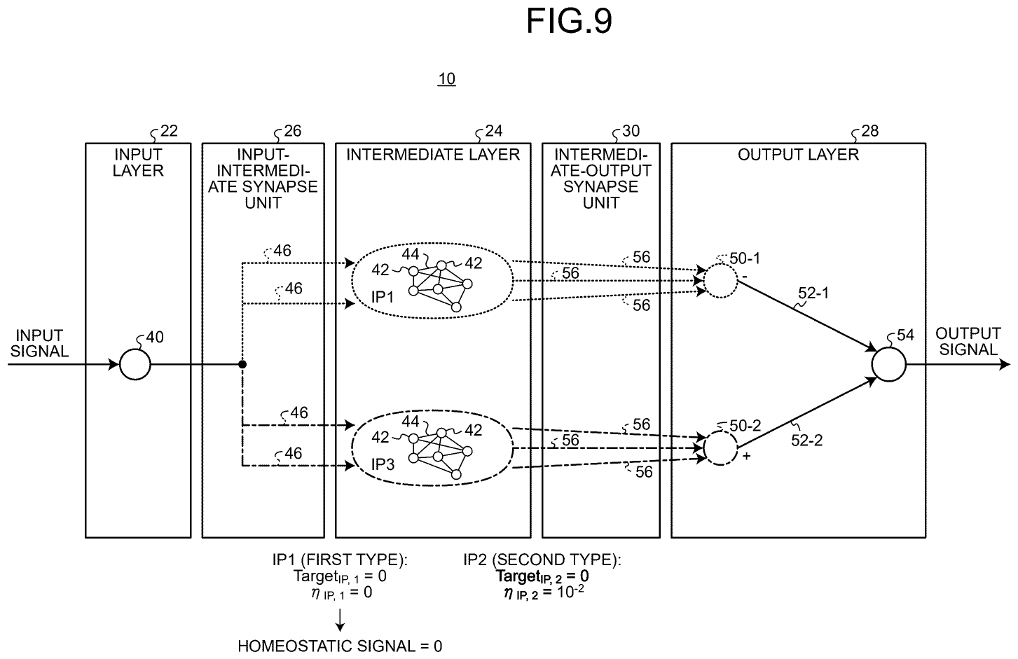

FIG. 9 is a diagram illustrating a configuration of the signal processing device 10 according to the ninth embodiment. The signal processing device 10 according to the ninth embodiment has a configuration in a case of P=2. That is, the P types of intermediate neurons 42 are the first type of intermediate neurons 42-1 and the second type of intermediate neurons 42-2.

Furthermore, in the N intermediate neurons 42 according to the ninth embodiment, the homeostatic signal in the first type of intermediate neuron 42 that is one of the two types of intermediate neurons 42-1 is 0, and the homeostatic signal in the second type of intermediate neuron 42-2 different from the first type changes with the lapse of time.

For example, in the first type intermediate neuron 42, the value of the corresponding row of η_{IP} in Equation (2) is set to 0. In the second type intermediate neurons 42, a real number other than 0 is set as the value of the corresponding row of η_{IP} in the Equation (2), and an optional real number is set as the value of the corresponding row of Target_{IP}.

That is, the first type intermediate neuron 42-1 changes the state value with the lapse of time in accordance with at least one of one or more intermediate input signals or one or more intermediate signals corresponding to the state value of each of the first type intermediate neurons 42-1 among the intermediate signals, without using the homeostatic signal.

On the other hand, the second type intermediate neuron 42-2 changes the state value with the lapse of time in accordance with at least one of one or more intermediate input signals or one or more intermediate signals having the second type intermediate neuron 42-2 of the intermediate signals as the preceding neuron, and the homeostatic signal.

In addition, the output layer 28 according to the ninth embodiment includes two output neurons 50 as the P output neurons 50, and includes two output synapses 52 as the P output synapses 52, similarly to the third embodiment.

While FIG. 9 illustrates an example in which one input signal is input, M input signals may be input to the signal processing device 10 according to the ninth embodiment. In this case, the output layer 28 includes two output neurons 50 and two output synapses 52 for each of the M groups corresponding to the M input signals. Then, the two output neurons 50 and the two output synapses 52 included in each of the M groups operate similarly to a case where one input signal is input.

### Update of Intermediate Synaptic Load According to STDP

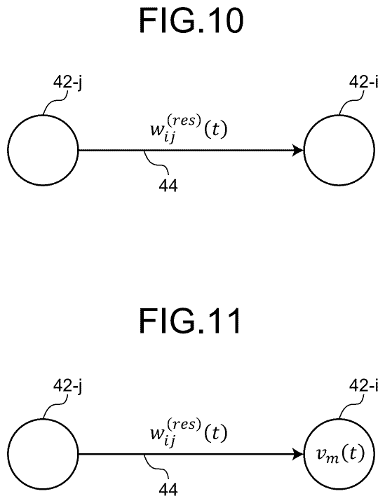

FIG. 10 is a diagram for describing update of an intermediate synaptic load according to STDP.

In each of the first to ninth embodiments, at least some of the intermediate synapses 44 may update the set intermediate synaptic load according to STDP.

For example, an intermediate synaptic load at a first time (t), which is set for the intermediate synapse 44 in which the j-th intermediate neuron 42-j among the N intermediate neurons 42 is a preceding neuron and the i-th intermediate neuron 42-i among the N intermediate neurons 42 is a subsequent neuron, is represented as wᵢⱼ^{(res)}(t). In addition, an intermediate synaptic load at a second time (t−tₚᵣₑ), which is set for the intermediate synapse 44 having the j-th intermediate neuron 42-j as a preceding neuron and the i-th intermediate neuron 42-i as a subsequent neuron and is before the first time (t) by a predetermined time step, is represented as wᵢⱼ^{(res)}(t−tₚᵣₑ). Note that i and j are integers of 1 or more and N or less.

In this case, when updating is performed according to STDP, wᵢⱼ^{(res)}(t) is

expressed by Equation (4) below.

$${w}_{ij}^{( res )} ( t ) = {w}_{ij}^{( res )} ( t - {t}_{pre} ) + {η}_{STDP} ( {x}_{i} ( t ) {x}_{j} ( t - {t}_{pre} ) - {x}_{i} ( t - {t}_{pre} ) {x}_{j} ( t ) ) \qquad ( 4 )$$

ηSTDP is a predetermined constant. xⱼ(t) represents a state value output from the preceding neuron at the first time (t). xⱼ(t−tₚᵣₑ) represents a state value output from the preceding neuron at the second time (t−tₚᵣₑ). xᵢ(t) represents a state value output from the subsequent neuron at the first time (t). xᵢ(t−tₚᵣₑ) represents a state value output from the subsequent neuron at the second time (t−tₚᵣₑ).

That is, as shown in Equation (4), the intermediate synapse 44 that performs the update according to the STDP calculates a first value obtained by multiplying the state value (xⱼ(t)) output from the preceding neuron at the first time (t) by the state value xᵢ(t−tₚᵣₑ) output from the subsequent neuron at the second time (t−tₚᵣₑ), which is one time step before the first time (t). In addition, the intermediate synapse 44 that performs the update according to the STDP calculates a second value obtained by multiplying the state value (xⱼ(t−tₚᵣₑ)) output from the preceding neuron at the second time (t−tₚᵣₑ) by the state value xᵢ(t) output from the subsequent neuron at the first time (t). Then, the intermediate synapse 44 that performs the update according to STDP calculates the intermediate synaptic load (wᵢⱼ^{(res)}(t)) at the first time (t) by adding a value obtained by multiplying the difference obtained by subtracting the second value from the first value by a predetermined constant (ηSTDP) to the intermediate synaptic load (wᵢⱼ^{(res)}(t−tₚᵣₑ)) at the second time (t−tₚᵣₑ).

Note that some of the intermediate synapses 44 may not update the intermediate synaptic load according to the STDP. For example, some of the intermediate synapses 44 may have an intermediate synaptic load fixed at a constant value.

### Update of Intermediate Synaptic Load According to Fusi Rule

FIG. 11 is a diagram for describing the update of the intermediate synaptic load according to the Fusi rule (SDSP rule).

In each of the first to ninth embodiments, at least some of the intermediate synapses 44 may update the set intermediate synaptic load according to the Fusi rule (SDSP rule).

Each of the intermediate synapses 44 acquires a membrane potential held by the subsequent neuron when updating the intermediate synaptic load based on the Fusi rule.

For example, the membrane potential at the first time (t) held by the N intermediate neurons 42 is represented as Vₘ(t). In this case, Vₘ(t) is expressed by Equation (5) below.

$${V}_{m} ( t ) = {W}^{( i n )} u ( t ) + {W}^{( res )} X ( t - 1 ) \qquad ( 5 )$$

Vₘ(t) represents a matrix of N rows and one column.

An intermediate synaptic load (wᵢⱼ^{(res)}(t)) at the first time (t), which is set for the intermediate synapse 44 having the j-th intermediate neuron 42-j as a preceding neuron and the i-th intermediate neuron 42-i as a subsequent neuron, is expressed by Equation (6) below.

$${w}_{ij}^{( res )} ( t ) = {w}_{ij}^{( res )} ( t - 1 ) + LR \times H ( {v}_{m , i} ( t ) ) \qquad ( 6 )$$

wᵢⱼ^{(res)}(t−1) represents the intermediate synaptic load one time step before the first time (t). LR represents a learning rate and is a predetermined constant. v_{m,i}(t) represents the membrane potential of the subsequent neuron. For example, the membrane potential of the i-th intermediate neuron 42-i is included in the i-th row of Vₘ(t).

In addition, H(u) is represented by a function shown in Equation (7) below.

$$H ( u ) = \{ \begin{matrix}1 … u ≧ {V}_{UP \_ threshold} \\ - 1 … u ≦ {V}_{DOWN \_ threshold} \\ 0 … {V}_{DOWN \_ threshold} < u < {V}_{UP \_ threshold}\end{matrix} \qquad ( 7 )$$

H(u) is 1 when u is equal to or greater than V_{UP_threshold}, and is −1 when u is equal to or less than V_{DOWN_threshold}. H(u) is 0 when u is larger than V_{DOWN_threshold} and smaller than V_{UP_threshold}. V_{UP_threshold} represents an upper limit threshold. V_{DOWN_threshold} represents a lower limit threshold.

The intermediate synapse 44 that performs the update according to the Fusi rule increases the intermediate synaptic load (wᵢⱼ^{(res)}(t)) when the membrane potential of the subsequent neuron is equal to or greater than the upper limit threshold, and decreases the intermediate synaptic load (wᵢⱼ^{(res)}(t)) when the membrane potential of the subsequent neuron is equal to or less than the lower limit threshold. In addition, the intermediate synapse 44 that performs the update according to the Fusi rule does not change the intermediate synaptic load (wᵢⱼ^{(res)}(t)) when the membrane potential of the subsequent neuron is smaller than the upper limit threshold and larger than the lower limit threshold.

Note that some of the intermediate synapses 44 may not update the intermediate synaptic load according to the Fusi rule. For example, some of the intermediate synapses 44 may have an intermediate synaptic load fixed at a constant value.

### Modification of Output Neuron 50

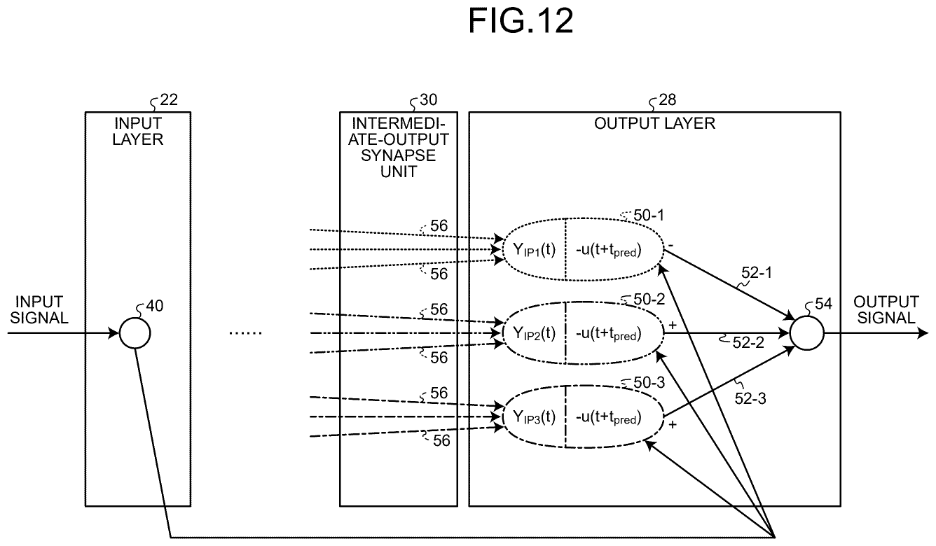

FIG. 12 is a diagram illustrating a modification of an output neuron 50.

In each of the first and third to ninth embodiments, each of the P output neurons 50 included in the output layer 28 may further generate a difference signal representing a difference between the combined signal to be output and a signal (u(t+t_{pred})) after a preset time in the input signal (u(t)). Then, in this case, the intermediate-output synaptic load set for each of the intermediate-output synapses 56 is learned such that the difference signal calculated by each of the P output neurons 50 becomes 0. As a result, the intermediate-output synaptic load set to each of the intermediate-output synapses 56 is learned such that, when a normal input signal is input, an abnormal component included in an input signal after a preset time is output from each of the P output neurons 50.

Furthermore, in a case where M input signals are input in the second embodiment or each of the third to ninth embodiments, each of the (M×P) output neurons 50 included in the output layer 28 may output a similar difference signal. In this case, each of the (M×P) output neurons 50 generates a difference signal representing a difference between the combined signal to be output and a signal after a preset time with respect to a corresponding input signal among the M input signals. Then, the intermediate-output synaptic load set to each of the intermediate-output synapses 56 is learned such that the difference signal of each of the M groups becomes 0.

Note that each of the P output neurons 50 included in the output layer 28 may output an absolute value of a difference between the combined signal output before a preset time and the input signal input at the present time. Then, in this case, the intermediate-output synaptic load set to each of the intermediate-output synapses 56 may be learned such that the absolute value of the difference calculated in this manner becomes 0. In a case where M input signals are input, each of the (M×P) output neurons 50 may similarly calculate the absolute value of the difference.

### Modification of Output Layer 28

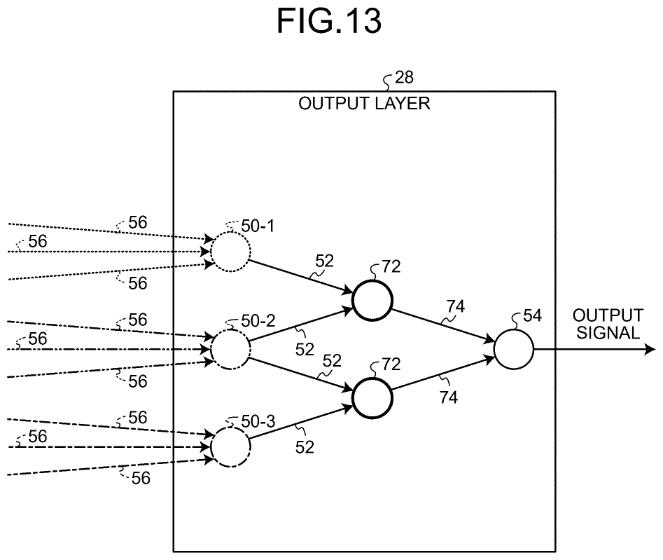

FIG. 13 is a diagram illustrating a modification of the output layer 28.

In each of the first and third to ninth embodiments, the output layer 28 has a two-stage configuration in which an input signal is output via two neurons. However, the output layer 28 may have a multistage configuration of three or more stages in which an input signal is output via three or more neurons.

In the present modification, the output layer 28 has a three-stage configuration of neurons. In this case, the output layer 28 further includes a plurality of output layer intermediate neurons 72 and a plurality of output layer intermediate synapses 74.

In the present modification, in the output synapses 52, any output neuron 50 among the P output neurons 50 is set as a preceding neuron, and any output layer intermediate neuron 72 among the output layer intermediate neurons 72 is set as a subsequent neuron. Then, each of the output synapses 52 outputs a signal obtained by multiplying the combined signal output from the preceding neuron by the set output synaptic load to the subsequent neuron.

Each of the output layer intermediate neurons 72 adds signals output from each of two or more output neurons 50 having itself as a subsequent neuron among the output synapses 52 to generate an output layer intermediate signal, and outputs the generated output layer intermediate signal.

The output layer intermediate synapses 74 correspond to the output layer intermediate neurons 72 on one-to-one basis. A predetermined load is set to each of the output layer intermediate synapses 74. In each of the output layer intermediate synapses 74, the corresponding output layer intermediate neuron 72 among the output layer intermediate neurons 72 is set as a preceding neuron, and the final output neuron 54 is set as a subsequent neuron. Each of the output layer intermediate synapses 74 outputs a signal obtained by multiplying the output layer intermediate signal output from the preceding neuron by a set load to the subsequent neuron.

In the present modification, the final output neuron 54 generates an output signal corresponding to a signal output from each of the output layer intermediate synapses 74, and outputs the generated output signal.

Even with such a configuration, the final output neuron 54 can generate and output an output signal by linearly combining the combined signals output from the respective P output neurons 50.

In addition, in the output layer 28, the configuration from the output layer intermediate neurons 72 to the final output neuron 54 may be a multilayer structure through more neurons. In addition, each of the output layer intermediate neurons 72 may execute activation function processing and processing using an input signal. In addition, in the output layer 28, the configuration from the output layer intermediate neurons 72 to the final output neuron 54 may be a deep learning model, a recurrent neural network, or a reservoir computing in which the final output neuron 54 is a layer of an output stage.

Note that FIG. 13 illustrates a modification of the output layer 28 in a case where one input signal is input. However, M input signals may be input to the signal processing device 10. In this case, the output layer 28 has a multistage configuration between the P output neurons 50 and the group final neuron 62 for each of the M groups corresponding to the M input signals, similarly to the case where one input signal is input.

### Modification of Input-Intermediate Synapse Unit 26

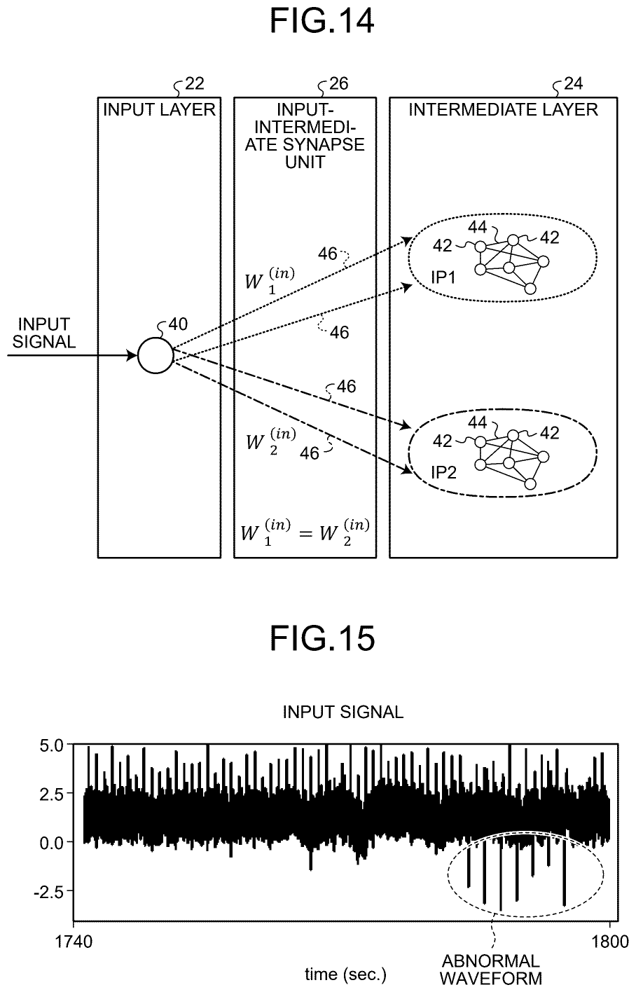

FIG. 14 is a diagram illustrating a modification of the input-intermediate synapse unit 26.

In the intermediate layer 24 according to the sixth to ninth embodiments, N intermediate neurons 42 independently constitute a recurrent neural network for each type. Therefore, in the sixth to ninth embodiments, the one or more input-intermediate synapses 46 included in the input-intermediate synapse unit 26 are grouped into P synapse groups for each type of subsequent neuron.

In this modification, each of the P synapse groups includes Q input-intermediate synapses 46. Therefore, the number of Q input-intermediate synapses 46 in each synapse group is the same. Further, the Q input-intermediate synapses 46 included in each of the P synapse groups are set with the same set of Q input-intermediate synaptic loads.

For example, the intermediate layer 24 includes the first type of intermediate neurons 42 (IP1) and the second type of intermediate neurons 42 (IP2). In this case, the input-intermediate synapse unit 26 includes a first synapse group corresponding to the first type intermediate neuron 42 (IP1) and a second synapse group corresponding to the second type intermediate neuron 42 (IP2).

The Q input-intermediate synaptic loads set for the Q input-intermediate synapses 46 included in the first synapse group are represented by W₁⁽ⁱⁿ⁾. The Q input-intermediate synaptic loads set for the Q input-intermediate synapses 46 included in the second synapse group are represented by W₂⁽ⁱⁿ⁾. In this case, a relationship of W₁⁽ⁱⁿ⁾=W₂⁽ⁱⁿ⁾ is established.

The signal processing device 10 according to such a modification can avoid an increase in the input difference for each of the P types with respect to the N intermediate neurons 42, and can accurately detect abnormalities.

Note that, in a case where M input signals are input, P synapse groups are set for each of the M input signals in the input-intermediate synapse unit 26. Then, in this case, in the input-intermediate synapse unit 26, for each of the M input signals, sets of Q input-intermediate synaptic loads that are the same as each other are set for the Q input-intermediate synapse 46 included in each of the P synapse groups.

Note that the input-intermediate synapse units 26 according to the first to fifth embodiments may also be grouped into P synapse groups. In this case, the number of each of the P synapse groups is the same (for example, Q). Further, the Q input-intermediate synapses 46 included in each of the P synapse groups are set with the same set of Q input-intermediate synaptic loads. As described above, the input-intermediate synapse unit 26 according to the modification illustrated in FIG. 4 can also be applied to the first to fifth embodiments.

### Modification of Update Rule of Intermediate Neuron 42

Next, a modification of the update rule of the intermediate neuron 42 will be described.

In each of the first to ninth embodiments, each of the N intermediate neurons 42 may operate in accordance with a leakage integral ignition model. In this case, each of the N intermediate neurons 42 holds the membrane potential, sets the state value to 1 when the membrane potential exceeds a preset threshold potential, and resets the held membrane potential. Each of the N intermediate neurons 42 sets the state value to 0 when the membrane potential does not exceed a preset threshold potential.

Each of the N intermediate neurons 42 operating in accordance with the leakage integral ignition model changes the membrane potential with the lapse of time. For example, each of the N intermediate neurons 42 changes the membrane potential with the lapse of time based on Equation (8) below.

$${τ}_{m} \frac{{dV}_{m} ( t )}{dt} = - ( {V}_{m} ( t ) - {V}_{rest} ) + {R}_{m} I ( t ) \qquad ( 8 )$$

Vₘ(t) represents the membrane potential at time t. Vᵣₑₛₜ represents a resting membrane potential. Rₘ represents a film resistance. I(t) represents the input current at time t. τₘ represents a time constant.

In a case where the N intermediate neurons 42 operate in accordance with the leakage integral ignition model in this manner, the time constant τₘ may be different for each of the P types. As a result, the response frequency of the N intermediate neurons 42 changes for each type, and the update rule of the state value changes. Therefore, the N intermediate neurons 42 that operate in accordance with the leakage integral ignition model can include P types of intermediate neurons 42 having different update rules by including P types of intermediate neurons 42 having different time constants τₘ.

Furthermore, in each of the first to ninth embodiments, in a case where the intermediate layer 24 processes an analog signal or in a case where the intermediate layer 24 processes a multi-valued discrete value or continuous value digital signal, the N intermediate neurons 42 may output state values defined by Equation (9) below.

$$X ( t ) = ( 1 - α ) X ( t - 1 ) + α tanh ( {W}^{( i n )} u ( t ) + {W}^{( res )} X ( t - 1 ) ) \qquad ( 9 )$$

In this case, the leakage rate α of the N intermediate neurons 42 may be different for each of the P types. As a result, the N intermediate neurons 42 changes, for each type, the update rule of the state value changes. Therefore, when the intermediate layer 24 processes an analog signal, or when the intermediate layer 24 processes a multi-valued discrete value or continuous value digital signal, the N intermediate neurons 42 include the P types of intermediate neurons 42 having different leakage rates α, so that the P types of intermediate neurons 42 having different update rules can be included.

Furthermore, in each of the first to ninth embodiments, each of the N intermediate neurons 42 may be an output limiting neuron whose output is limited.

For example, the state value of the output limiting neuron for which the upper limit value is set is expressed as Equation (10) below.

$$\{ \begin{matrix}\begin{matrix}X ( t ) = ( 1 - α ) X ( t - 1 ) + \\ α tanh ( {W}^{( i n )} u ( t ) + {W}^{( res )} X ( t - 1 ) )\end{matrix} & ( X ( t ) \leq {X}_{threshold}^{+} ) \\ X ( t ) = X ( t - 1 ) & ( X ( t ) > {X}_{threshold}^{+} )\end{matrix} \qquad ( 10 )$$

X⁺_{threshold} represents a matrix of N rows and one column. The X⁺_{threshold} includes upper limit values of the N state values output from the N intermediate neurons 42. The value included in X⁺_{threshold} is a real number of 0 or more. The upper limit value of the n-th intermediate neuron 42 is included in the n-th row of X⁺_{threshold}.

In this case, the N intermediate neurons 42 have different set upper limit values for each of the P types. As a result, the N intermediate neurons 42 changes, for each type, the update rule of the state value changes. Note that each of the N intermediate neurons 42 can function as a neuron whose output is not substantially limited by setting the upper limit value to the maximum value that the state value can take.

Furthermore, for example, the state value of the output limiting neuron for which the lower limit value is set is expressed as Equation (11) below.

$$\{ \begin{matrix}\begin{matrix}X ( t ) = ( 1 - α ) X ( t - 1 ) + \\ α tanh ( {W}^{( i n )} u ( t ) + {W}^{( res )} X ( t - 1 ) )\end{matrix} & ( X ( t ) \geq {X}_{threshold}^{-} ) \\ X ( t ) = X ( t - 1 ) & ( X ( t ) < {X}_{threshold}^{-} )\end{matrix} \qquad ( 11 )$$

X⁻_{threshold} represents a matrix of N rows and one column. The X⁻_{threshold} includes lower limit values of the N state values output from the N intermediate neurons 42. The value included in X⁻_{threshold} is a real number of 0 or less. The lower limit value of the n-th intermediate neuron 42 is included in the n-th row of the X⁻_{threshold}.

In this case, the N intermediate neurons 42 have different lower limit values set for each of the P types. As a result, the N intermediate neurons 42 changes, for each type, the update rule of the state value changes. Note that each of the N intermediate neurons 42 can function as a neuron whose output is not substantially limited by setting the lower limit value to the minimum value that the state value can take.

Furthermore, for example, the state value of the output limiting neuron for which the upper limit value and the lower limit value are set is expressed as Equation (12) below.

$$\{ \begin{matrix}\begin{matrix}X ( t ) = ( 1 - α ) X ( t - 1 ) + \\ α tanh ( {W}^{( i n )} u ( t ) + {W}^{( res )} X ( t - 1 ) )\end{matrix} & ( {X}_{threshold}^{-} \leq X ( t ) \leq {X}_{threshold}^{-} ) \\ X ( t ) = X ( t - 1 ) & \begin{matrix}( X ( t ) < {X}_{threshold}^{-} or \\ X ( t ) > {X}_{threshold}^{-} )\end{matrix}\end{matrix} \qquad ( 12 )$$

In this case, the N intermediate neurons 42 have different combinations of the lower limit value and the upper limit value set for each of the P types. As a result, the N intermediate neurons 42 changes, for each type, the update rule of the state value changes. Note that each of the N intermediate neurons 42 can function as a neuron whose output is not substantially limited by setting the upper limit value to the maximum value that the state value can take and setting the lower limit value to the minimum value that the state value can take.

Furthermore, for example, the state value of the output limiting neuron in which the absolute value of the upper limit value matches the absolute value of the lower limit value and the upper limit value and the lower limit value are set is expressed as Equation (13) below.

$$\{ \begin{matrix}\begin{matrix}X ( t ) = ( 1 - α ) X ( t - 1 ) + \\ α tanh ( {W}^{( i n )} u ( t ) + {W}^{( res )} X ( t - 1 ) )\end{matrix} & ( \vert X ( t ) \vert \leq {X}_{threshold} ) \\ X ( t ) = X ( t - 1 ) & ( \vert X ( t ) \vert > {X}_{threshold} )\end{matrix} \qquad ( 13 )$$

X_{threshold} represents a matrix of N rows and one column. The X_{threshold} includes the absolute value of the upper limit value (or the absolute value of the lower limit value) of the N state values output from the N intermediate neurons 42. The value included in X_{threshold} is a real number of 0 or more. The absolute value of the upper limit value (or the absolute value of the lower limit value) of the n-th intermediate neuron 42 is included in the n-th row of X_{threshold}.

In this case, the N intermediate neurons 42 have different upper limit values (lower limit values) set for each of the P types. As a result, the N intermediate neurons 42 changes, for each type, the update rule of the state value changes. Note that each of the N intermediate neurons 42 can function as a neuron whose output is not substantially limited by setting the absolute value of the upper limit value (or the absolute value of the lower limit value) to the maximum value that the state value can take.

As described above, the N intermediate neurons 42 include the P types of intermediate neurons 42 having different upper limit values or lower limit values for output restriction, and thus, can include the P types of intermediate neurons 42 having different update rules.

### Simulation

A simulation result in a case where an input signal including an abnormal waveform is given to the signal processing device 10 having the learned configuration of the ninth embodiment will be described.

FIG. 15 is a waveform diagram of an input signal used for simulation. The input signal used for the simulation is a signal obtained by superimposing an abnormal waveform on white noise having a standard deviation of 0.721. A circled part in FIG. 15 is an abnormal waveform.

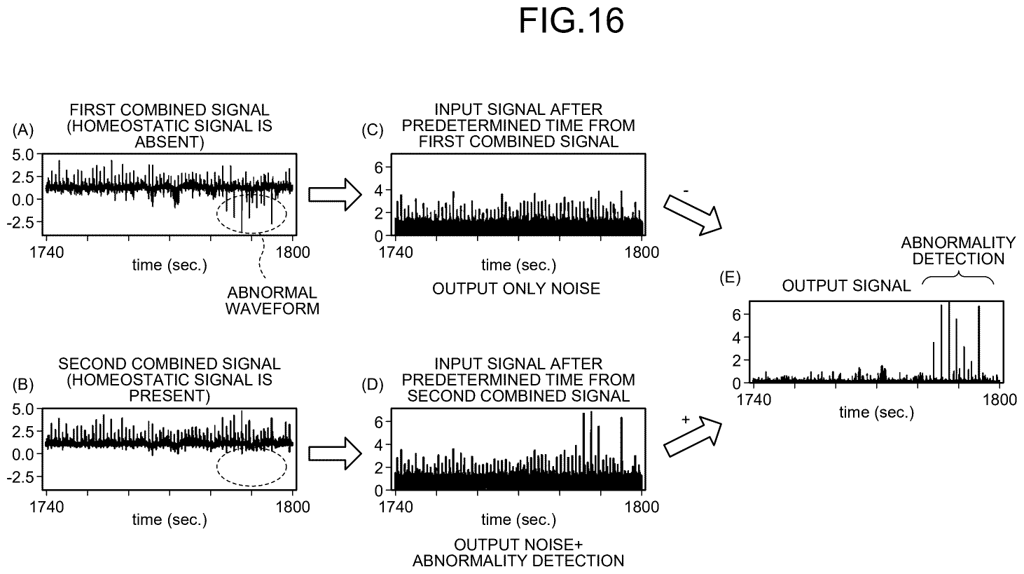

FIG. 16 is a waveform diagram of a signal representing a simulation result.

A part-A of FIG. 16 illustrates the first combined signal. The part-A of FIG. 16 represents a signal obtained by linearly combining the state values of the first type intermediate neurons 42 in which the homeostatic signal (T_{IP}(t)) is 0. As illustrated in a circled part in the part-A of FIG. 16, a signal component of an abnormal waveform appears in the first combined signal.

A part-B of FIG. 16 represents the second combined signal. The part-B of FIG. 16 represents a signal obtained by linearly combining the state values of the second type intermediate neurons 42 in which the homeostatic signal (T_{IP}(t)) is not 0. As illustrated in a circled part in the part-B of FIG. 16, the signal component of the abnormal waveform does not appear in the second combined signal.

A part-C of FIG. 16 represents a signal obtained by subtracting the input signal after a predetermined time from the first combined signal. As illustrated in the part-C of FIG. 16, in the signal obtained by subtracting the input signal after the predetermined time from the first combined signal, only the component of the white noise appears, and the signal component of the abnormal waveform does not appear.

A part-D of FIG. 16 represents a signal obtained by subtracting the input signal after a predetermined time from the second combined signal. As illustrated in the part-D of FIG. 16, in the signal obtained by subtracting the input signal after the predetermined time from the second combined signal, the signal component of the abnormal waveform is superimposed on the component of the white noise.

A part-E of FIG. 16 illustrates an output signal output from the final output neuron 54. The part-E of FIG. 16 represents a signal obtained by inverting the positive/negative sign of a signal obtained by subtracting the input signal after the predetermined time from the first combined signal and linearly adding the signals without inverting the positive/negative sign of a signal obtained by subtracting the input signal after the predetermined time from the second combined signal.

As illustrated in the part-E of FIG. 16, the output signal includes a signal component in which a signal component of the abnormal waveform is emphasized. Therefore, for example, a device at the subsequent stage of the final output neuron 54 or the final output neuron 54 can detect whether or not an abnormal component is included in the input signal by comparing the output signal with a threshold.

### Abnormality Detection System 100

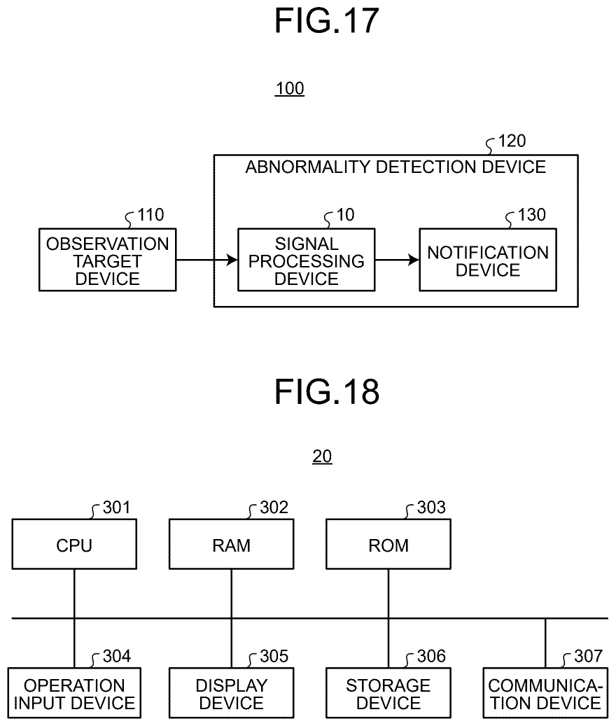

FIG. 17 is a diagram illustrating a configuration of an abnormality detection system 100 to which the signal processing device 10 is applied.

The abnormality detection system 100 includes an observation target device 110 and an abnormality detection device 120. When the abnormalities occur in the observation target device 110, the abnormality detection system 100 notifies an administrator or another device that the abnormalities have occurred, for example.

The observation target device 110 operates continuously. For example, the observation target device 110 is a medical device, infrastructure equipment, or the like. The observation target device 110 is not limited to such a device, and may be any device as long as the device continuously operates.

The abnormality detection device 120 includes a signal processing device 10 and a notification device 130.

The signal processing device 10 has the same configuration as the signal processing device 10 according to the first to ninth embodiments described above. The signal processing device 10 detects the abnormalities in the observation target device 110. For example, the signal processing device 10 detects the abnormalities that occur instantaneously in the observation target device 110. Even during a period of normal operation, the observation target device 110 may operate or behave irregularly and instantaneously differently from the normal state. Such an operation or behavior is, for example, a precursor of a failure or significant performance degradation in the observation target device 110. By continuously detecting such an instantaneous abnormality in the observation target device 110 in real time, the signal processing device 10 can find a precursor of a failure or significant capability degradation in the observation target device 110.

The signal processing device 10 acquires one or more input signals whose values change in the time direction, that is, one or more input signals in time series, obtained by observing the observation target device 110. The signal processing device 10 outputs an output signal representing an abnormal component generated in the observation target device 110 based on the acquired input signal.

The notification device 130 acquires the output signal from the signal processing device 10. The notification device 130 determines whether there is the abnormalities based on the output signal, and notifies the administrator of the determination result by, for example, displaying the determination result on a display device or outputting a voice from a voice output device. Furthermore, the notification device 130 may transmit the output signal or the determination result based on the output signal to another device such as a server via, for example, a network.

Since the abnormality detection system 100 having such a configuration uses the signal processing device 10 according to the first to ninth embodiments, it is possible to accurately detect the abnormalities of the observation target device 110 with a simple configuration by executing signal processing in a state of including noise without performing spectrum analysis on the input signal by the digital processing circuit. In addition, since the configuration of the signal processing device 10 is simple, the abnormality detection system 100 having such a configuration can detect the abnormalities in a terminal device having low processing capability near the observation target device 110, for example.

### Hardware Configuration of Information Processing Device

FIG. 18 is a diagram illustrating an example of a hardware configuration of an information processing device 20.

The signal processing device 10 may be implemented by a computer (information processing device 20) having a hardware configuration as illustrated in FIG. 18, for example, instead of the analog circuit or the digital circuit. In this case, the information processing device 20 includes a central processing unit (CPU) 301, a random access memory (RAM) 302, a read only memory (ROM) 303, an operation input device 304, a display device 305, a storage device 306, and a communication device 307. These units are connected to each other via a bus.

The CPU 301 is a hardware processor that executes arithmetic processing, control processing, and the like in accordance with a computer program(s). The CPU 301 uses a predetermined area of the RAM 302 as a work area, and executes various types of processing in cooperation with programs stored in the ROM 303, the storage device 306, and the like.

The RAM 302 is a memory such as a synchronous dynamic random access memory (SDRAM). The RAM 302 functions as a work area of the CPU 301. The ROM 303 is a memory that stores programs and various types of information in a non-rewritable manner.

The operation input device 304 is an input device such as a mouse and a keyboard. The operation input device 304 receives information operationally input from the user as an instruction signal, and outputs an instruction signal to the CPU 301.

The display device 305 is a display device such as a liquid crystal display (LCD). The display device 305 displays various types of information based on a display signal from the CPU 301.

The storage device 306 is a device that writes and reads data in and from a semiconductor storage medium such as a flash memory, a magnetically or optically recordable storage medium, or the like. The storage device 306 writes and reads data to and from the storage medium under the control of the CPU 301. The communication device 307 communicates with an external device via a network in accordance with control from the CPU 301.

The program executed by the computer has a module configuration including an input layer module, an intermediate layer module, an input-intermediate synapse module, an output layer module, and an intermediate-output synapse module.

This program is developed and executed on the RAM 302 by the CPU 301 (processor), thereby causing the computer to function as the input layer 22, the intermediate layer 24, the input-intermediate synapse unit 26, the output layer 28, and the intermediate-output synapse unit 30. Note that a part or all of the input layer 22, the intermediate layer 24, the input-intermediate synapse unit 26, the output layer 28, and the intermediate-output synapse unit 30 may be implemented by a hardware circuit.

In addition, the program executed by the computer is provided by being recorded in a computer-readable recording medium such as a CD-ROM, a flexible disk, a CD-R, or a digital versatile disk (DVD) as a file in a format that can be installed or executed in the computer.

Furthermore, the program may be stored on a computer connected to a network such as the Internet and provided by being downloaded via the network. Furthermore, the program may be provided or distributed via a network such as the Internet. Furthermore, the program executed by the information processing device 20 may be provided as a computer program product by being stored in a non-transitory computer readable recording medium such as the ROM 303 or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### SUPPLEMENT

The above-described embodiments can be summarized in the following technical schemes.

### Technical Scheme 1

A signal processing device executing signal processing according to a neural network, the signal processing device comprising
a hardware processor connected to a memory and configured to function as:
   an input layer configured to acquire M input signals (M is an integer of 1 or more);
   an intermediate layer configured to acquire one or more intermediate input signals corresponding to the M input signals and generate intermediate signals based on the one or more intermediate input signals; and
   an output layer configured to acquire intermediate output signals and output an output signal corresponding to the intermediate output signals, wherein
the intermediate layer includes
   N intermediate neurons (N is an integer of 2 or more) each being configured to output a state value, and
   intermediate synapses configured to generate the intermediate signals,
each of the intermediate synapses generates a corresponding intermediate signal among the intermediate signals in accordance with the state value output from one of the N intermediate neurons,
each of the intermediate output signals is a signal corresponding to the state value output by the one of the N intermediate neurons,
each of the N intermediate neurons changes the state value with the lapse of time based on a predetermined update rule in accordance with at least one of the one or more intermediate input signals or the intermediate signals, and
the N intermediate neurons include P types (P is an integer of 2 or more and N or less) whose update rules are different.

### Technical Scheme 2

The signal processing device according to the technical scheme 1, wherein
each of the N intermediate neurons changes the state value with the lapse of time in accordance with at least one of the one or more intermediate input signals or the intermediate signals, and a homeostatic signal serving to change the state value in a direction of a target value with a preset intensity, and
each of the P types of intermediate neurons has the setting intensity or the target value in the homeostatic signal, each being different from that of other types of intermediate neurons.

### Technical Scheme 3

The signal processing device according to the technical scheme 2, wherein the N intermediate neurons have a homeostatic signal of 0 in one type of the P types of intermediate neurons.

### Technical Scheme 4

The signal processing device according to the technical scheme 2 or 3, wherein
the output layer includes
   (M×P) output neurons, and
   a final output neuron configured to output the output signal,
the (M×P) output neurons are grouped into M groups, each group including P output neurons,
the M groups correspond to the M input signals on one-to-one basis,
the P output neurons included in each of the M groups correspond one-to-one to the P types of intermediate neurons,
each of the P output neurons included in each of the M groups outputs a combined signal representing an output state value obtained by linearly combining the state values of one or more intermediate neurons of a corresponding type among the N intermediate neurons, and
the final output neuron generates the output signal by linearly combining the combined signal output from each of the (M×P) output neurons.

### Technical Scheme 5

The signal processing device according to the technical scheme 4, wherein
the output layer further includes output synapses, and
each of the output synapses corresponds to any of the (M×P) output neurons and outputs a signal obtained by multiplying the combined signal output from the corresponding output neuron by an output synaptic load that is a preset real number,
the final output neuron generates the output signal by linearly adding signals output from each of the output synapses, and,
for each of the M groups,
   a first output synapse among the output synapses outputs a signal obtained by inverting the positive/negative sign of the combined signal output from a first output neuron among the P output neurons included in the corresponding group, and
   a second output synapse among the output synapses outputs a signal that does not invert the positive/negative sign of the combined signal output from a second output neuron among the P output neurons included in the corresponding group.

### Technical Scheme 6

The signal processing device according to the technical scheme 4, wherein the output signal includes, for each of the M groups, a component obtained by adding
a signal obtained by inverting the positive/negative sign of a first combined signal that is the combined signal output from a first output neuron among the P output neurons, and
a signal obtained by not inverting the positive/negative sign of a second combined signal that is the combined signal output from a second output neuron different from the first output neuron among the P output neurons.

### Technical Scheme 7

The signal processing device according to the technical scheme 5 or 6, wherein
each of the intermediate synapses is set with an intermediate synaptic load, and
each of the intermediate synapses outputs a signal obtained by multiplying the state value output from a preceding neuron being one of the N intermediate neurons by the set intermediate synaptic load to a subsequent neuron being one of the N intermediate neurons, the signal being output as the corresponding intermediate signal among the intermediate signals.

### Technical Scheme 8

The signal processing device according to the technical scheme 7, wherein each of the N intermediate neurons changes the state value with the lapse of time in accordance with at least one of
one or more intermediate input signals, or
one or more intermediate signals for which the intermediate neuron of the same type among the intermediate signals is set as the preceding neuron.

### Technical Scheme 9

The signal processing device according to the technical scheme 8, wherein
the P types of intermediate neurons includes a first type of intermediate neuron and a second type of intermediate neuron,
the first type intermediate neuron changes the state value with the lapse of time in accordance with at least one of the one or more intermediate input signals or the one or more first type intermediate signals for which the first type intermediate neuron among the intermediate signals is set as a preceding neuron, and
the second type intermediate neuron changes the state value with the lapse of time in accordance with at least one of the one or more intermediate input signals or the one or more second type intermediate signals for which the second type intermediate neuron among the intermediate signals is set as a preceding neuron, and the homeostatic signal.

### Technical Scheme 10

The signal processing device according to any one of the technical schemes 7 to 9, wherein
the hardware processor is further configured to function as intermediate-output synapses,
each of the intermediate-output synapses is set with an intermediate-output synaptic load, and outputs a signal obtained by multiplying the state value output from a preceding neuron which being one of the N intermediate neurons by the set intermediate-output synaptic load as a corresponding intermediate output signal among the intermediate output signals, and
each of the intermediate-output synapses outputs the intermediate output signal to an output neuron corresponding to a type of a preceding neuron among the (M×P) output neurons.

### Technical Scheme 11

The signal processing device according to the technical scheme 10, wherein the intermediate-output synaptic load to be set to each of the intermediate-output synapses is learned for each of the M groups such that, when M normal input signals are input, the combined signal output from each of the P output neurons becomes a signal after a preset time in a corresponding normal input signal among the M normal input signals.

### Technical Scheme 12

The signal processing device according to the technical scheme 10, wherein
each of the P output neurons included in each of the M groups of the output layer generates a difference signal representing a difference between the combined signal to be output and a signal after a preset time in a corresponding input signal among the M input signals, and
the intermediate-output synaptic load set in each of the intermediate-output synapses is learned such that the difference signal of each of the M groups becomes 0 when the M normal input signals are input.

### Technical Scheme 13

The signal processing device according to any one of the technical schemes 7 to 12, wherein
the input layer includes M input neurons corresponding to the M input signals on one-to-one basis, and
each of the M input neurons acquires a corresponding input signal among the M input signals and outputs an input state value in accordance with the corresponding input signal.

### Technical scheme 14

The signal processing device according to the technical scheme 13, wherein
the hardware processor is further configured to function as one or more input-intermediate synapses,
each of the one or more input-intermediate synapses is set with an input-intermediate synaptic load, and outputs a signal obtained by multiplying the input state value output from any of the M input neurons by the set input-intermediate synaptic load as a corresponding intermediate input signal among the one or more intermediate input signals,
the one or more input-intermediate synapses are grouped into P synapse groups corresponding to the P types of intermediate neurons,
each of the P groups of synapses includes Q input-intermediate synapses (Q is an integer of 2 or more), and
the Q input-intermediate synapses included in each of the P synapse groups are set with the same set of Q input-intermediate synaptic loads.

### Technical Scheme 15

The signal processing device according to any one of the technical schemes 7 to 14, wherein at least some of the intermediate synapses updates the intermediate synaptic load in accordance with a difference between
a value obtained by multiplying the state value output from the preceding neuron at a first time and the state value output from the subsequent neuron at a second time, the second time being a predetermined time step before the first time, and
a value obtained by multiplying the state value output from the preceding neuron at the second time and the state value output from the subsequent neuron at the first time.

### Technical Scheme 16

The signal processing device according to any one of the technical schemes 7 to 14, wherein at least some of the intermediate synapses updates the intermediate synaptic load in accordance with a membrane potential generated by a subsequent neuron.

### Technical Scheme 17

A signal processing method implemented by a computer, the computer executing signal processing according to a neural network, the method comprising:
executing processing according to an input layer serving to acquire M input signals (M is an integer of 1 or more);
executing processing according to an intermediate layer serving to acquire one or more intermediate input signals corresponding to the M input signals and generate intermediate signals based on the one or more intermediate input signals; and
executing processing according to an output layer serving to acquire intermediate output signals and output an output signal corresponding to the intermediate output signals, wherein
the intermediate layer includes
   N intermediate neurons (N is an integer of 2 or more) each being configured to output a state value, and
   intermediate synapses configured to generate the intermediate signals,
each of the intermediate synapses generates a corresponding intermediate signal among the intermediate signals in accordance with the state value output from one of the N intermediate neurons,
each of the intermediate output signals is a signal corresponding to the state value output by the one of the N intermediate neurons,
each of the N intermediate neurons changes the state value with the lapse of time based on a predetermined update rule in accordance with at least one of the one or more intermediate input signals or the intermediate signals, and
the N intermediate neurons include P types (P is an integer of 2 or more and N or less) whose update rules are different.

### Technical Scheme 18

A computer program product comprising a non-transitory computer-readable recording medium on which a computer program is recorded, the computer program causing a computer to execute signal processing according to a neural network and to function as:
an input layer serving to acquire M input signals (M is an integer of 1 or more);
an intermediate layer serving to acquire one or more intermediate input signals corresponding to the M input signals and generate intermediate signals based on the one or more intermediate input signals; and
an output layer serving to acquire intermediate output signals and output an output signal corresponding to the intermediate output signals, wherein
the intermediate layer includes
   N intermediate neurons (N is an integer of 2 or more) each being configured to output a state value, and
   intermediate synapses configured to generate the intermediate signals,
each of the intermediate synapses generates a corresponding intermediate signal among the intermediate signals in accordance with the state value output from one of the N intermediate neurons,
each of the intermediate output signals is a signal corresponding to the state value output by the one of the N intermediate neurons,
each of the N intermediate neurons changes the state value with the lapse of time based on a predetermined update rule in accordance with at least one of the one or more intermediate input signals or the intermediate signals, and
the N intermediate neurons include P types (P is an integer of 2 or more and N or less) whose update rules are different.

What is claimed is:

1. A signal processing device executing signal processing according to a neural network, the signal processing device comprising
a hardware processor connected to a memory and configured to function as:
an input layer configured to acquire M input signals (M is an integer of 1 or more);
an intermediate layer configured to acquire one or more intermediate input signals corresponding to the M input signals and generate intermediate signals based on the one or more intermediate input signals; and
an output layer configured to acquire intermediate output signals and output an output signal corresponding to the intermediate output signals, wherein
the intermediate layer includes
N intermediate neurons (N is an integer of 2 or more) each being configured to output a state value, and
intermediate synapses configured to generate the intermediate signals,
each of the intermediate synapses generates a corresponding intermediate signal among the intermediate signals in accordance with the state value output from one of the N intermediate neurons,
each of the intermediate output signals is a signal corresponding to the state value output by the one of the N intermediate neurons,
each of the N intermediate neurons changes the state value with the lapse of time based on a predetermined update rule in accordance with at least one of the one or more intermediate input signals or the intermediate signals, and
the N intermediate neurons include P types (P is an integer of 2 or more and N or less) whose update rules are different.

2. The signal processing device according to claim 1, wherein
each of the N intermediate neurons changes the state value with the lapse of time in accordance with at least one of the one or more intermediate input signals or the intermediate signals, and a homeostatic signal serving to change the state value in a direction of a target value with a preset intensity, and
each of the P types of intermediate neurons has the setting intensity or the target value in the homeostatic signal, each being different from that of other types of intermediate neurons.

3. The signal processing device according to claim 2, wherein the N intermediate neurons have a homeostatic signal of 0 in one type of the P types of intermediate neurons.

4. The signal processing device according to claim 2, wherein
the output layer includes
(M×P) output neurons, and
a final output neuron configured to output the output signal,
the (M×P) output neurons are grouped into M groups, each group including P output neurons,
the M groups correspond to the M input signals on one-to-one basis,
the P output neurons included in each of the M groups correspond one-to-one to the P types of intermediate neurons,
each of the P output neurons included in each of the M groups outputs a combined signal representing an output state value obtained by linearly combining the state values of one or more intermediate neurons of a corresponding type among the N intermediate neurons, and
the final output neuron generates the output signal by linearly combining the combined signal output from each of the (M×P) output neurons.

5. The signal processing device according to claim 4, wherein
the output layer further includes output synapses, and
each of the output synapses corresponds to any of the (M×P) output neurons and outputs a signal obtained by multiplying the combined signal output from the corresponding output neuron by an output synaptic load that is a preset real number,
the final output neuron generates the output signal by linearly adding signals output from each of the output synapses, and,
for each of the M groups,
a first output synapse among the output synapses outputs a signal obtained by inverting the positive/negative sign of the combined signal output from a first output neuron among the P output neurons included in the corresponding group, and
a second output synapse among the output synapses outputs a signal that does not invert the positive/negative sign of the combined signal output from a second output neuron among the P output neurons included in the corresponding group.

6. The signal processing device according to claim 4, wherein the output signal includes, for each of the M groups, a component obtained by adding
a signal obtained by inverting the positive/negative sign of a first combined signal that is the combined signal output from a first output neuron among the P output neurons, and
a signal obtained by not inverting the positive/negative sign of a second combined signal that is the combined signal output from a second output neuron different from the first output neuron among the P output neurons.

7. The signal processing device according to claim 5, wherein
each of the intermediate synapses is set with an intermediate synaptic load, and
each of the intermediate synapses outputs a signal obtained by multiplying the state value output from a preceding neuron being one of the N intermediate neurons by the set intermediate synaptic load to a subsequent neuron being one of the N intermediate neurons, the signal being output as the corresponding intermediate signal among the intermediate signals.

8. The signal processing device according to claim 7, wherein each of the N intermediate neurons changes the state value with the lapse of time in accordance with at least one of
one or more intermediate input signals, or
one or more intermediate signals for which the intermediate neuron of the same type among the intermediate signals is set as the preceding neuron.

9. The signal processing device according to claim 8, wherein
the P types of intermediate neurons includes a first type of intermediate neuron and a second type of intermediate neuron,
the first type intermediate neuron changes the state value with the lapse of time in accordance with at least one of the one or more intermediate input signals or the one or more first type intermediate signals for which the first type intermediate neuron among the intermediate signals is set as a preceding neuron, and
the second type intermediate neuron changes the state value with the lapse of time in accordance with at least one of the one or more intermediate input signals or the one or more second type intermediate signals for which the second type intermediate neuron among the intermediate signals is set as a preceding neuron, and the homeostatic signal.

10. The signal processing device according to claim 7, wherein
the hardware processor is further configured to function as intermediate-output synapses,
each of the intermediate-output synapses is set with an intermediate-output synaptic load, and outputs a signal obtained by multiplying the state value output from a preceding neuron which being one of the N intermediate neurons by the set intermediate-output synaptic load as a corresponding intermediate output signal among the intermediate output signals, and
each of the intermediate-output synapses outputs the intermediate output signal to an output neuron corresponding to a type of a preceding neuron among the (M×P) output neurons.

11. The signal processing device according to claim 10, wherein the intermediate-output synaptic load to be set to each of the intermediate-output synapses is learned for each of the M groups such that, when M normal input signals are input, the combined signal output from each of the P output neurons becomes a signal after a preset time in a corresponding normal input signal among the M normal input signals.

12. The signal processing device according to claim 10, wherein
each of the P output neurons included in each of the M groups of the output layer generates a difference signal representing a difference between the combined signal to be output and a signal after a preset time in a corresponding input signal among the M input signals, and
the intermediate-output synaptic load set in each of the intermediate-output synapses is learned such that the difference signal of each of the M groups becomes 0 when the M normal input signals are input.

13. The signal processing device according to claim 7, wherein
the input layer includes M input neurons corresponding to the M input signals on one-to-one basis, and
each of the M input neurons acquires a corresponding input signal among the M input signals and outputs an input state value in accordance with the corresponding input signal.

14. The signal processing device according to claim 13, wherein
the hardware processor is further configured to function as one or more input-intermediate synapses,
each of the one or more input-intermediate synapses is set with an input-intermediate synaptic load, and outputs a signal obtained by multiplying the input state value output from any of the M input neurons by the set input-intermediate synaptic load as a corresponding intermediate input signal among the one or more intermediate input signals,
the one or more input-intermediate synapses are grouped into P synapse groups corresponding to the P types of intermediate neurons,
each of the P groups of synapses includes Q input-intermediate synapses (Q is an integer of 2 or more), and
the Q input-intermediate synapses included in each of the P synapse groups are set with the same set of Q input-intermediate synaptic loads.

15. The signal processing device according to claim 7, wherein at least some of the intermediate synapses updates the intermediate synaptic load in accordance with a difference between
a value obtained by multiplying the state value output from the preceding neuron at a first time and the state value output from the subsequent neuron at a second time, the second time being a predetermined time step before the first time, and
a value obtained by multiplying the state value output from the preceding neuron at the second time and the state value output from the subsequent neuron at the first time.

16. The signal processing device according to claim 7, wherein at least some of the intermediate synapses updates the intermediate synaptic load in accordance with a membrane potential generated by a subsequent neuron.

17. A signal processing method implemented by a computer, the computer executing signal processing according to a neural network, the method comprising:
executing processing according to an input layer serving to acquire M input signals (M is an integer of 1 or more);
executing processing according to an intermediate layer serving to acquire one or more intermediate input signals corresponding to the M input signals and generate intermediate signals based on the one or more intermediate input signals; and
executing processing according to an output layer serving to acquire intermediate output signals and output an output signal corresponding to the intermediate output signals, wherein
the intermediate layer includes
N intermediate neurons (N is an integer of 2 or more) each being configured to output a state value, and
intermediate synapses configured to generate the intermediate signals,
each of the intermediate synapses generates a corresponding intermediate signal among the intermediate signals in accordance with the state value output from one of the N intermediate neurons,
each of the intermediate output signals is a signal corresponding to the state value output by the one of the N intermediate neurons,
each of the N intermediate neurons changes the state value with the lapse of time based on a predetermined update rule in accordance with at least one of the one or more intermediate input signals or the intermediate signals, and
the N intermediate neurons include P types (P is an integer of 2 or more and N or less) whose update rules are different.

18. A computer program product comprising a non-transitory computer-readable recording medium on which a computer program is recorded, the computer program causing a computer to execute signal processing according to a neural network and to function as:
an input layer serving to acquire M input signals (M is an integer of 1 or more);
an intermediate layer serving to acquire one or more intermediate input signals corresponding to the M input signals and generate intermediate signals based on the one or more intermediate input signals; and
an output layer serving to acquire intermediate output signals and output an output signal corresponding to the intermediate output signals, wherein
the intermediate layer includes
N intermediate neurons (N is an integer of 2 or more) each being configured to output a state value, and
intermediate synapses configured to generate the intermediate signals,
each of the intermediate synapses generates a corresponding intermediate signal among the intermediate signals in accordance with the state value output from one of the N intermediate neurons,
each of the intermediate output signals is a signal corresponding to the state value output by the one of the N intermediate neurons,
each of the N intermediate neurons changes the state value with the lapse of time based on a predetermined update rule in accordance with at least one of the one or more intermediate input signals or the intermediate signals, and
the N intermediate neurons include P types (P is an integer of 2 or more and N or less) whose update rules are different.
